(19) United States
(12) Patent Application Publication
(10) Pub. No.: US 2005/0142413 A1
(43) Pub. Date: Jun. 30, 2005

(54) Separator for fuel cell, method for producing the same, and fuel cell using the same

(75) Inventors: Hajime Kimura, Hirakata (JP); Akihiro Matsumoto, Kobe-shi (JP); Keiko Ohtsuka, Toyonaka-shi (JP); Junzo Fukunaga, Toyonaka-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignees: SANSHO KAKOU CO., LTD., Osaka 560-0021 (JP); OSAKA MUNICIPAL GOVERNMENT, Osaka 530-8201 (JP)

(21) Appl. No.: 10/506,248

(22) PCT Filed: Mar. 10, 2003
(86) PCT No.: PCT/JP03/02770

(30) Foreign Application Priority Data
Mar. 20, 2002 (JP) 2002-78630
Oct. 23, 2002 (JP) 2002-308363

(51) Int. Cl. H01M 8/02; H01B 1/24; H01M 8/10; B29C 45/00

(52) U.S. Cl. 429/34; 252/511; 429/30; 264/328.1

(57) ABSTRACT

The present invention provides a fuel cell separator obtainable by hot-molding an electroconductive resin composition that comprises a thermosetting resin (A) which comprises a compound with a dihydrobenzoxazine ring (a), a compound (b) reactive with a phenolic hydroxyl group formed by opening of a dihydrobenzoxazine ring, and a latent curing agent (c), and an electroconductive material (B); a process for producing the separator; and a fuel cell comprising the separator.

### TECHNICAL FIELD

The present invention relates to a fuel cell separator, a process for producing the same, and a fuel cell comprising the separator.

### BACKGROUND ART

Fuel cells, which produce electricity by electrochemically reacting hydrogen and oxygen, are attract attention as an environmentally clean energy source that, unlike other power generators, does not cause problems with noise or air pollutants such as NOₓ and SOₓ. Fuel cells are classified by operating temperature, components, etc. into four types: phosphoric acid, molten carbonate, solid oxide and polymer electrolyte fuel cells. Among these, polymer electrolyte fuel cells have a high power density, can be miniaturized, and operate at lower temperatures than other types of fuel cells, and thus can be easily stopped and started. Therefore, polymer electrolyte fuel cells show promise for use as a power sources for cars, homes, etc. and have attracted special attention in recent years.

A fuel cell fundamentally comprises three components: an anode, a cathode and an electrolyte. The anode is made of a laminate of a catalyst that draws electrons from hydrogen, a fuel hydrogen gas diffusion layer, and a separator as a collector. The cathode is made of a laminate of a catalyst to react protons with oxygen, an air diffusion layer, and a separator. A fuel cell separator has, on one side, channels for passage of a fuel gas mainly consisting of hydrogen, and on the other side, channels for passage of an oxidizing gas such as air, and separates the gases from each other. Further, the separator plays an important role in electrically connecting the cell with any adjacent cells by contacting with the electrodes of the adjacent cells.

Fuel cell separators are required to have the characteristics of being gas-impermeable to avoid fuel gas leakage, being highly electroconductive to achieve high energy conversion efficiency, and having high mechanical strength so as not to be broken or otherwise damaged when incorporated into fuel cells. Known processes for producing separators having these characteristics include a process in which an expanded graphite sheet is molded at high pressure (Japanese Unexamined Patent Publication No. 1986-7570), a process in which baked carbon is impregnated with a resin, followed by curing (Japanese Unexamined Patent Publication No. 1996-222241), and a process in which a phenol resin is added as a binder to a carbon powder, followed by hot-molding, baking and carbonization (Japanese Unexamined Patent Publication No. 1992-214072).

However, none of the above processes give a separator with sufficient performance. Moreover, the above processes involve a baking step that requires a high temperature and long period of time, and include a step of machining the baked carbon into a desired shape. Thus, these production processes are complicated and expensive.

Japanese Unexamined Patent Publication No. 1985-246568 discloses a process for producing a separator easily and inexpensively, the process comprising adding, as a binder, a thermosetting resin such as a phenol resin to a carbon powder, and carrying out hot compression molding in a mold of a desired shape. However, when a phenol resin is used, the curing is effected by a condensation reaction, which generates volatiles such as formaldehyde, condensation water and ammonia gas during the reaction process. Therefore, in the above process, the volatiles need to be thoroughly removed by breathing. Insufficient breathing may cause blistering and internal voids in the molding, resulting in a separator unsatisfactory in electroconductivity, gas impermeability and mechanical strength. It is thus difficult to produce separators with stable performance by the above process.

### DISCLOSURE OF THE INVENTION

An object of the present invention is to provide a fuel cell separator that is well balanced and excellent in electroconductivity, gas impermeability, mechanical strength, dimensional stability, lightweight properties, moldability, etc., and that stably retains these performance characteristics for a long period of time; an inexpensive production process for the separator; and a fuel cell comprising the separator.

Other objects and features of the present invention will be apparent from the following description.

The present inventors conducted extensive research and found that, when a thermosetting resin (A) comprising a dihydrobenzoxazine ring-containing compound (a), a compound (b) reactive with a phenolic hydroxyl group formed by opening of a dihydrobenzoxazine ring, and a latent curing agent (c), is used as a binder for an electroconductive material (B), a fuel cell separator can be obtained which is superior in moldability and dimensional stability and which has excellent in electroconductivity, gas impermeability and mechanical strength. The present invention was thus accomplished.

The present invention provides the following fuel cell separators, production processes thereof, and fuel cells comprising the fuel cell separators.

1. A fuel cell separator obtainable by hot-molding an electroconductive resin composition that comprises:
a thermosetting resin (A) comprising a dihydrobenzoxazine ring-containing compound (a), a compound (b) reactive with a phenolic hydroxyl group formed by opening of a dihydrobenzoxazine ring, and a latent curing agent (c); and
an electroconductive material (B).

2. The fuel cell separator according to item 1, obtainable by hot-molding an electroconductive resin composition that comprises 1 to 50 wt. % of the thermosetting resin (A) and 99 to 50 wt. % of the electroconductive material (B).

3. The fuel cell separator according to item 1 or 2, wherein the electroconductive material (B) is a graphite.

4. The fuel cell separator according to item 3, wherein the graphite is at least one member selected from the group consisting of expanded graphites, flake graphites and artificial graphites.

5. The fuel cell separator according to item 3, wherein the graphite is a pulverized product or cutting powder of a graphite material.

6. The fuel cell separator according to any one of items 1 to 5, wherein the dihydrobenzoxazine ring-containing compound (a) has at least one functional group represented by formula (1) 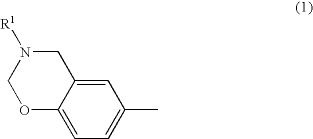
wherein R¹ is a substituted or unsubstituted alkyl group, a substituted or unsubstituted aryl group, a substituted or unsubstituted alkenyl group, a substituted or unsubstituted alkynyl group, or a substituted or unsubstituted aralkyl group.

7. The fuel cell separator according to any one of items 1 to 6, wherein the compound (b) reactive with a phenolic hydroxyl group formed by opening of a dihydrobenzoxazine ring has at least one functional group represented by formula (2) 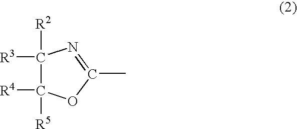
wherein R², R³, R⁴ and R⁵ are the same or different and each represents a hydrogen atom, an alkyl group or an aryl group.

8. The fuel cell separator according to any one of items 1 to 6, wherein the compound (b) reactive with a phenolic hydroxyl group formed by opening of a dihydrobenzoxazine ring is an epoxy resin.

9. The fuel cell separator according to any one of items 1 to 8, wherein the latent curing agent (c) is a compound that forms, when decomposed, an acidic compound and an amine compound.

10. The fuel cell separator according to item 9, wherein the compound that forms, when decomposed, an acidic compound and an amine compound is a reaction product of an organic or inorganic acid with an amine compound.

11. The fuel cell separator according to item 10, wherein the organic acid is at least one member selected from the group consisting of organic sulfonic acids, organic phosphoric acids and organic carboxylic acids.

12. The fuel cell separator according to item 10 or 11, wherein the amine compound is at least one member selected from the group consisting of monoalkanolamines, dialkanolamines and trialkanolamines, all of which may be substituted and are represented by formula (3) 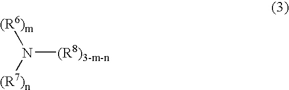
wherein R⁶ and R⁷ are the same or different and each represents a hydrogen atom, a substituted or unsubstituted C₁₋₁₀ alkyl group or a substituted or unsubstituted C₆₋₁₀ aryl group; R⁸ is a hydroxyl-containing C₁₋₈ alkyl group; m and n are each 0, 1 or 2, and m+n≦2.

13. The fuel cell separator according to any one of items 1 to 12, which has a resistivity of 30 mΩ·cm or less, a helium permeability of 30 cm³/m²·24 h·atm or less and a flexural strength of 30 to 100 MPa.

14. The fuel cell separator according to any one of items 1 to 13, which has a metal plate incorporated therein.

15. A process for producing a fuel cell separator, comprising the steps of:
compressing into tablets an electroconductive resin composition that comprises a thermosetting resin (A) comprising a dihydrobenzoxazine ring-containing compound (a), a compound (b) reactive with a phenolic hydroxyl group formed by opening of a dihydrobenzoxazine ring, and a latent curing agent (c), and an electroconductive material (B); and
heat-curing the tablets by compression molding.

16. A process for producing a fuel cell separator, comprising the step of heat-curing, by transfer molding or injection molding, an electroconductive resin composition that comprises:
a thermosetting resin (A) comprising a dihydrobenzoxazine ring-containing compound (a), a compound (b) reactive with a phenolic hydroxyl group formed by opening of a dihydrobenzoxazine ring, and a latent curing agent (c); and
an electroconductive material (B).

17. A fuel cell comprising a fuel cell separator according to any one of items 1 to 14.

18. The fuel cell according to item 17, which is a polymer electrolyte fuel cell.

In the fuel cell separator of the present invention, the thermosetting resin (A) for use as a binder for the electroconductive material (B) comprises a dihydrobenzoxazine ring-containing compound (a), a compound (b) reactive with a phenolic hydroxyl group formed by opening of a dihydrobenzoxazine ring, and a latent curing agent (c).

The dihydrobenzoxazine ring-containing compound (a) for use in the present invention is not limited as long as it has, in the molecule, at least one functional group containing a dihydrobenzoxazine ring represented by formula (1) 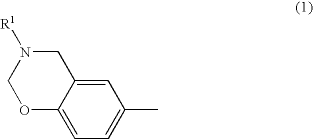
wherein R¹ is a substituted or unsubstituted alkyl group, a substituted or unsubstituted aryl group, a substituted or unsubstituted alkenyl group, a substituted or unsubstituted alkynyl group, or a substituted or unsubstituted aralkyl group; and forms a phenolic hydroxyl group by the ring opening reaction. A compound with at least one functional group containing such a dihydrobenzoxazine ring can be prepared by, for example, reacting, with or without a solvent, a compound with at least one phenolic hydroxyl group, a compound with at least one amino group and a formaldehyde compound. Such dihydrobenzoxazine ring-containing compounds may be used singly or in combination.

The compound with at least one phenolic hydroxyl group is not limited as long as it is a compound in which at least one ortho position of the phenol nucleus is unsubstituted. Examples of such compounds include phenol, o-, m- or p-cresol, 2,3-xylenol, 2,4-xylenol, 2,5-xylenol, 4-n-nonylphenol, 4-n-octylphenol, 2,3,5-trimethylphenol, 4-n-hexylphenol and like alkylphenols; and p-cyclohexylphenol, p-cumylphenol, p-phenylphenol, p-allylphenol, α- or β-naphthol and like compounds with one phenolic hydroxyl group. Examples of compounds with two or more phenolic hydroxyl groups include catechol, hydroquinone, resorcinol, 1,5-dihydroxynaphthalene, 2,6-dihydroxynaphthalene, 2,2′-dihydroxybiphenyl, 4,4′-dihydroxybiphenyl, 4,4′-oxybisphenol, 4,4′-dihydroxybenzophenone, bisphenol A, bisphenol E, bisphenol F, bisphenol S, difluorobisphenol A, 4,4′-[2,2,2-trifluoro-1-(trifluoromethyl)ethylidene]bisphenol, 4,4′-cyclopentylidenebisphenol, 4,4′-(dimethylsilylene)bisphenol, 4,4′-cyclohexylidenebisphenol, terpenediphenol, 1,3-bis(4-hydroxyphenyl)adamantane, 1,3,5-trihydroxybenzene, 4,4′,4″-methylidenetrisphenol, etc. Also usable are oligomers obtained by reacting the above phenol compounds with formalin by a known process, such as phenol novolac type phenol resins, cresol novolac type phenol resins, bisphenol A novolac type phenol resins, bisphenol F novolac type phenol resins, bisphenol S novolac type phenol resins, naphthol novolac type phenol resins and resol type phenol resins. Other phenolic hydroxyl-containing oligomers and polymers are also usable, including triazine-modified phenol resins, dicyclopentadiene-modified phenol resins, paraxylene-modified phenol resins, xylylene-modified phenol resins, melamine-modified phenol resins, benzoguanamine-modified phenol resins, maleimide-modified phenol resins, silicone-modified phenol resins, butadiene-modified phenol resins, naphthol-modified phenol resins, naphthalene-modified phenol resins, biphenyl-modified phenol resins and like modified phenol resins; poly(p-vinylphenol) and copolymers thereof, etc. Such compounds with at least one phenolic hydroxyl group may be used singly or in combination.

Examples of compounds with at least one amino group include methylamine, ethylamine, n-propylamine, n-butylamine, n-dodecylamine, n-nonylamine, cyclopentylamine, cyclohexylamine, allylamine and like alkylmonoamines and alkenylmonoamines; aniline, p-cyanoaniline, p-bromoaniline, o-toluidine, m-toluidine, p-toluidine, 2,4-xylidine, 2,5-xylidine, 3,4-xylidine, α-naphthylamine, β-naphthylamine, 3-aminophenylacetylene and like aromatic monoamines; etc. Also usable are benzylamine, 2-amino-benzylamine, 1,3-diaminopropane, 1,4-diaminobutane, 1,10-diaminodecane, 2,7-diaminofluorene, 1,4-diaminocyclohexane, 9,10-diaminophenanthrene, 1,4-diaminopiperazine, p-phenylenediamine, 4,4′-diaminobenzophenone, 4,4′-diaminodiphenylsulfone, 4,4′-diaminodiphenylmethane, 4,4′-diaminobiphenyl, 4,4′-oxydianiline, tetraminofluorene, tetraminodiphenyl ether, melamine, etc.

Usable formaldehyde compounds include formalin, i.e., an aqueous formaldehyde solution; trioxane, and paraformaldehyde, i.e., polymers of formaldehyde; etc.

Usable reaction solvents include 1,4-dioxane, tetrahydrofuran, 1-propanol, 1-butanol, methanol, etc.

In the above reaction, it is preferable to use 1 mol of amino groups and 2 mol or more of formaldehyde compound relative to 1 mol of phenolic hydroxyl groups. The reaction temperature is preferably 80 to 100° C. The reaction proceeds with difficulty at a reaction temperature lower than 80° C., whereas a reaction temperature over 100° C. promotes a side reaction in which the produced dihydrobenzoxazine ring opens to form an oligomer. The reaction is complete in 2 to 6 hours, although the reaction time depends on the reaction temperature.

After completion of the reaction, the solvent, if any, is distilled off, and as necessary, the reaction mixture is washed with water or alkali to remove the unreacted phenolic hydroxyl-containing compound, amine and formaldehyde compound, to thereby give a compound with a dihydrobenzoxazine structure.

Compounds with a dihydrobenzoxazine ring obtainable in the above manner include, for example, compounds represented by formulas (4) to (7).
Formula (4): 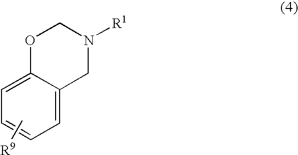
wherein R¹ is a substituted or unsubstituted alkyl group, a substituted or unsubstituted aryl group, a substituted or unsubstituted alkenyl group, a substituted or unsubstituted alkynyl group or a substituted or unsubstituted aralkyl group; and R⁹ is a hydrogen atom, a substituted or unsubstituted alkyl group, a substituted or unsubstituted aryl group, a substituted or unsubstituted alkoxy group, a substituted or unsubstituted alkenyl group, a substituted or unsubstituted alkynyl group, a substituted or unsubstituted aralkyl group, one to four halogen atom(s), one to four nitro group(s), one to four cyano group(s), one to four alkoxycarbonyl group(s), one to four hydroxyl group(s), one to four alkyl(aryl)sulfonyl group(s), or the like.
Formula (5): 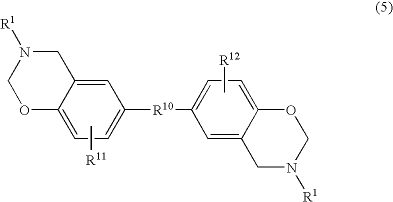
wherein R¹ is a substituted or unsubstituted alkyl group, a substituted or unsubstituted aryl group, a substituted or unsubstituted alkenyl group, a substituted or unsubstituted alkynyl group or a substituted or unsubstituted aralkyl group; R¹⁰ is a single bond, a substituted or unsubstituted alkylene group, a substituted or unsubstituted arylene group, a substituted or unsubstituted alkenylene group, a substituted or unsubstituted alkynylene group, a substituted or unsubstituted aralkylene group, a carbonyl group, an ether group, a thioether group, a silylene group, a siloxane group, a methylene ether group, an ester group, a sulfonyl group, or the like; R¹¹ and R¹² are the same or different and each represents a hydrogen atom, a substituted or unsubstituted alkyl group, a substituted or unsubstituted aryl group, a substituted or unsubstituted alkoxy group, a substituted or unsubstituted alkenyl group, a substituted or unsubstituted alkynyl group, a substituted or unsubstituted aralkyl group, one to three halogen atom(s), one to three nitro group(s), one to three cyano group(s), one to three alkoxycarbonyl group(s), one to three hydroxyl group(s), one to three alkyl(aryl)sulfonyl group(s), or the like. Examples of R¹⁰ include the following: 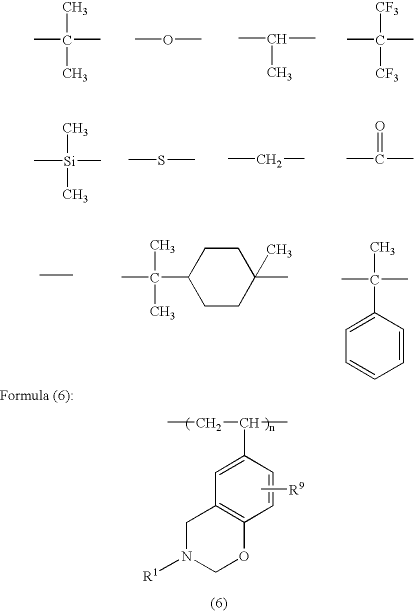
wherein R¹ is a substituted or unsubstituted alkyl group, a substituted or unsubstituted aryl group, a substituted or unsubstituted alkenyl group, a substituted or unsubstituted alkynyl group or a substituted or unsubstituted aralkyl group; R⁹ is a hydrogen atom, a substituted or unsubstituted alkyl group, a substituted or unsubstituted aryl group, a substituted or unsubstituted alkoxy group, a substituted or unsubstituted alkenyl group, a substituted or unsubstituted alkynyl group, a substituted or unsubstituted aralkyl group, a halogen atom, a nitro group, a cyano group, an alkoxycarbonyl group, a hydroxyl group, an alkyl(aryl)sulfonyl group, or the like; and n is an integer from 2 to 200.
Formula (7): 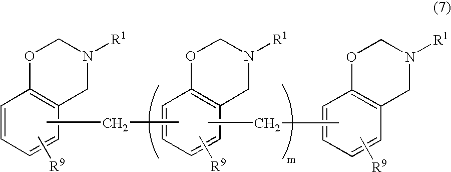
wherein R¹ is a substituted or unsubstituted alkyl group, a substituted or unsubstituted aryl group, a substituted or unsubstituted alkenyl group, a substituted or unsubstituted alkynyl group or a substituted or unsubstituted aralkyl group; R⁹ is a hydrogen atom, a substituted or unsubstituted alkyl group, a substituted or unsubstituted aryl group, a substituted or unsubstituted alkoxy group, a substituted or unsubstituted alkenyl group, a substituted or unsubstituted alkynyl group, a substituted or unsubstituted aralkyl group, a halogen atom, a nitro group, a cyano group, an alkoxycarbonyl group, a hydroxyl group, an alkyl(aryl)sulfonyl group or the like; and m is an integer from 0 to 100.

Among the above compounds, compounds represented by formulae (5) and (7) are preferable.

The compound (b) reactive with a phenolic hydroxyl group formed by opening of a dihydrobenzoxazine ring is not limited as long as it is capable of reacting with a phenolic hydroxyl group, and may be, for example, an epoxy resin, a 2-oxazoline compound or the like.

The epoxy resin for use in the present invention is not limited as long as it has at least one epoxy group in the molecule, and may be a known epoxy resin. Examples of usable epoxy resins include bisphenol A diglycidyl ether (DGEBA), bisphenol F diglycidyl ether, bisphenol S diglycidyl ether, biphenyl diglycidyl ether, tetrabromobisphenol A diglycidyl ether and like bisphenol type epoxy resins; phthalic acid diglycidyl ester, terephthalic acid diglycidyl ester, tetrahydrophthalic acid diglycidyl ester, hexahydrophthalic acid diglycidyl ester, dimer acid diglycidyl ester, adipic acid diglycidyl ester and like diglycidyl ester type epoxy resins; hexamethylene glycol diglycidyl ether and like polyol type epoxy resins; phenol novolac type epoxy resins, o-cresol novolac type epoxy resins (OCNEs), bisphenol-A novolac type epoxy resins and like polyfunctional phenol type epoxy resins; alicyclic diepoxy acetals, alicyclic diepoxy adipates, vinylcyclohexene dioxide and like alicyclic epoxy resins; N,N,N′,N′-tetraglycidyl-4,4′-diaminodiphenylmethane, N,N-diglycidylamino-1,3-glycidyl phenyl ether and like glycidyl amine type epoxy resins; triglycidyl isocyanurate, diglycidyl hydantoins, glycidyl glycide oxyalkyl hydantoin and like heterocyclic epoxy resins; naphthalene skeleton epoxy resins, urethane-modified epoxy resins, siloxane skeleton epoxy resins, homopolymers and copolymers of glycidyl (meth)acrylate, etc. These can be used singly or in combination.

The 2-oxazoline compound is not limited as long as it has, in the molecule, at least one functional group containing a 2-oxazoline ring represented by formula (2) 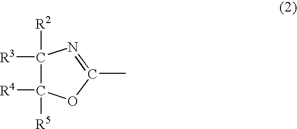
wherein R², R³, R⁴ and R⁵ are the same or different and each represents a hydrogen atom, an alkyl group or an aryl group. Examples of the alkyl group include C₁₋₆ alkyl groups such as methy, ethyl, propyl and butyl. Examples of the aryl group include C₆-10 aryl groups such as phenyl, tolyl, xylyl, naphthyl and p-chlorophenyl.

Specific examples of the 2-oxazoline compounds include mono(2-oxazoline) compounds such as 2-methyl-2-oxazoline, 2-ethyl-2-oxazoline, 2-propyl-2-oxazoline and like alkyl-substituted oxazolines; 2-phenyl-2-oxazoline, 2-tolyl-2-oxazoline, 2-xylyl-2-oxazoline and like aromatic substituted 2-oxazolines; etc. Specific examples also include bis(2-oxazoline) compounds such as 2,2′-bis(2-oxazoline), 2,2′-bis(4-methyl-2-oxazoline), 2,2′-bis(5-methyl-2-oxazoline), 2,2′-bis(5,5′-dimethyl-2-oxazoline), 2,2′-bis(4,4,4′,4′-tetramethyl-2-oxazoline), 1,2-bis(2-oxazoline-2-yl)ethane, 1,4-bis(2-oxazoline-2-yl)butane, 1,6-bis(2-oxazoline-2-yl)hexane, 1,8-bis(2-oxazoline-2-yl)octane, 1,4-bis(2-oxazoline-2-yl)cyclohexane, 1,2-bis(2-oxazoline-2-yl)benzene, 1,3-bis(2-oxazoline-2-yl)benzene (1,3-PBO), 1,4-bis(2-oxazoline-2-yl)benzene, 1,2-bis(5-methyl-2-oxazoline-2-yl)benzene, 1,3-bis(5-methyl-2-oxazoline-2-yl)benzene, 1,4-bis(5-methyl-2-oxazoline-2-yl)benzene, 1,4-bis(4,4′-dimethyl-2-oxazoline-2-yl)benzene, etc. Also usable are polyfunctional 2-oxazoline compounds such as 2-vinyl-2-oxazoline homopolymers, copolymers of 2-vinyl-2-oxazoline and styrene, copolymers of 2-vinyl-2-oxazoline and methyl methacrylate, etc. Among the above 2-oxazoline compounds, 2,2′-bis(2-oxazoline), 1,2-bis(2-oxazoline-2-yl)ethane, 1,4-bis(2-oxazoline-2-yl)cyclohexane, 1,3-bis(2-oxazoline-2-yl)benzene (1,3-PBO), 1,2-bis(5-methyl-2-oxazoline-2-yl)benzene, 1,3-bis(5-methyl-2-oxazoline-2-yl)benzene, 1,4-bis(5-methyl-2-oxazoline-2-yl)benzene, copolymers of 2-vinyl-2-oxazoline and styrene are preferable, and 1,3-bis(2-oxazoline-2-yl)benzene (1,3-PBO) is especially preferable. These can be used singly or in combination.

The latent curing agent (c) for use in the present invention is not limited as long as it decomposes when heated to thereby form an acidic compound and an amine compound. Such a curing agent can be easily obtained by reacting an amine compound with an organic or inorganic sulfonic acid, organic or inorganic phosphoric acid, or carboxylic acid at room or elevated temperature.

Examples of sulfonic acids usable for the synthesis of the latent curing agent include inorganic sulfonic acids such as sulfuric acid, amidosulfuric acid, etc.; and organic sulfonic acids such as methanesulfonic acid, ethanesulfonic acid, propanesulfonic acid, decanesulfonic acid, benzenesulfonic acid, phenolsulfonic acid, phenolsulfonic acid novolac, o-toluenesulfonic acid, m-toluenesulfonic acid, p-toluenesulfonic acid, p-methoxybenzenesulfonic acid, p-chlorobenzenesulfonic acid, p-nitrobenzenesulfonic acid, α- or β-naphthalenesulfonic acid, xylenesulfonic acid, p-dodecylbenzenesulfonic acid, trifluoromethansulfonic acid, etc. Usable phosphoric acids include inorganic phosphoric acids such as orthophosphoric acid, metaphosphoric acid, pyrophosphoric acid, phosphorous acid, phosphinic acid, tripolyphosphoric acid, and tetrapolyphosphoric acid; and organic phosphoric acids such as monophenyl phosphate, diphenyl phosphate, dicresyl phosphate, monomethoxyethyl phosphate, monoethoxyethyl phosphate, monoxylenyl phosphate, mono-n-butoxyethyl phosphate, mono(meth)acryloxyethyl phosphate and like phosphoric acid mono- or diesters and phosphorous acid mono- or diesters. Usable carboxylic acids include organic carboxylic acids such as formic acid, acetic acid, chloroacetic acid, dichloroacetic acid, trichloroacetic acid, fluoroacetic acid, difluoroacetic acid, trifluoroacetic acid, cyanoacetic acid, propionic acid, lactic acid, and (meth)acrylic acid and like aliphatic monocarboxylic acids; benzoic acid, o-, m- or p-hydroxybenzoic acid, o-, m- or p-toluic acid and like aromatic monocarboxylic acids; oxalic acid, malonic acid, succinic acid, glutaric acid, adipic acid, pimelic acid, suberic acid, dodecanedioic acid, maleic acid, fumaric acid and like aliphatic dicarboxylic acids; phthalic acid, isophthalic acid, terephthalic acid and like aromatic dicarboxylic acids; etc. Among these, preferable are phenolsulfonic acid, o-toluenesulfonic acid, m-toluenesulfonic acid, p-toluenesulfonic acid, p-dodecylbenzenesulfonic acid, p-methoxybenzenesulfonic acid, p-chlorobenzenesulfonic acid and like sulfonic acids; monophenyl phosphate, monoxylenyl phosphate, mono-n-butoxyethyl phosphate, mono(meth)acryloxyethyl phosphate and like phosphoric acids; trichloroacetic acid, trifluoroacetic acid, p-hydroxybenzoic acid, p-toluic acid, adipic acid, maleic acid, fumaric acid, terephthalic acid and like carboxylic acids, and particularly preferable is p-toluenesulfonic acid. These may be used singly or in combination.

The amine compound for use in the synthesis of the latent curing agent is not limited. Examples include methylamine, ethylamine, propylamine, isopropylamine, butylamine, hexylamine, heptylamine, diisopropylamine, diethylamine, triethylamine, cyclohexylamine, allylamine, 2-methoxyethylamine, 2-ethoxyethylamine and like alkylamines and alkenylamines; aniline, methylaniline, ethylaniline, o-, m- or p-toluidine, diphenylamine, α- or β-naphthylamine and like aromatic amines; benzylamine, dibenzylamine, pyridine, hexamethylenediamine, diethylenetriamine, p-phenylenediamine, m-phenylenediamine, 4,4′-diaminodiphenylmethane, 4,4′-diaminodiphenylsulfone, 4,4′-diaminobiphenyl, tolylenediamine, diaminophenol and like amines; etc.

Also usable as the amine compound for use in the synthesis of the latent curing agent are alkanolamines including monoalkanolamines, dialkanolamines and trialkanolamines, each of which may be substituted and is represented by formula (3) 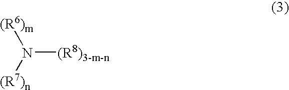
wherein R⁶ and R⁷ are the same or different and each represents a hydrogen atom, a substituted or unsubstituted C₁₋₁₀ alkyl group or a substituted or unsubstituted C₆₋₁₀ aryl group; and R⁸ is a hydroxyl-containing C₁₋₈ alkyl group; and m and n are each 0, 1 or 2 and m+n≦2. Each of R⁶ and R⁷ is, for example, a methyl, ethyl, n-propyl, isopropyl, n-butyl, isobutyl, t-butyl, n-pentyl, isopentyl, t-pentyl, phenyl or like group. Specific examples of such alkanolamines include ethanolamine, N-methylethanolamine, N-ethylethanolamine, N-n-butylethanolamine and like monoalkylethanolamines; N,N-dimethylethanolamine, N,N-diethylethanolamine, N,N-di-n-butylethanolamine and like dialkylethanolamines; N-n-propanolamine, N-methyl-n-propanolamine, N-ethyl-n-propanolamine, N-n-propyl-n-propanolamine and like monoalkyl-n-propanolamines; N,N-dimethyl-n-propanolamine, N,N-diethyl-n-propanolamine, N,N-di-n-propyl-n-propanolamine and like dialkyl-n-propanolamines; isopropanolamine, N-methylisopropanolamine, N-ethylisopropanolamine, N-butylisopropanolamine and like monoalkylisopropanolamines; N,N-dimethylisopropanolamine, N,N-diethylisopropanolamine, N,N-dibutylisopropanolamine and like dialkyl isopropanolamines; N-n-pentanolamine, N-n-hexanolamine, diethanolamine, N-n-butyldiethanolamine, N-phenyldiethanolamine, diisopropanolamine, N-phenylethanolamine, N-phenyl-N-ethylethanolamine, N-benzylethanolamine, N-benzyl-N-methylethanolamine, triethanolamine, N-(β-aminoethyl)ethanolamine, N-(γ-aminopropyl)ethanolamine, etc. Also usable are substituted alkanolamines such as N,N-bis(2-hydroxyethyl)isopropanolamine, 2-amino-1,3-propanediol, 3-amino-1,2-dihydroxypropane, 3-amino-3-phenyl-1-propanol, 2-amino-3-phenyl-1-propanol, 2-amino-2-methyl-1,3-propanediol, tris(hydroxymethyl)aminomethane, 2-(2-hydroxyethylamino)-2-hydroxymethyl-1,3-propanediol, 2-amino-2-methyl-1-propanol, 2-amino-3-methyl-1-butanol, etc.

The above amine compounds react with the above organic or inorganic acids to serve as curing agents with various latent thermal properties. These latent curing agents are solid or liquid at room temperature, and are neither evaporative nor acidic. However, these latent curing agents decompose when heated to thereby form an acidic compound and an amine compound, which are incorporated into the curing system to form a new thermosetting resin. Among the above amine compounds, preferable are methylamine, ethylamine, isopropylamine, n-butylamine, 2-methoxyethylamine, aniline, methylaniline, p-toluidine, benzylamine, diaminophenol, m-phenylenediamine, 4,4′-diaminodiphenylmethane, 4,4′-diaminodiphenylsulfone, ethanolamine, diethanolamine, n-propanolamine, isopropanolamine, N-ethylethanolamine, N,N-diethylethanolamine, N-phenylethanolamine, N-phenyldiethanolamine, N-benzylethanolamine, N-(β-aminoethyl)ethanolamine, 2-amino-1,3-propanediol and 3-amino-3-phenyl-1-propanol are preferable, diethanolamine and isopropanolamine are especially preferable. These may be used singly or in combination.

For preparation of the thermosetting resin (A) for use in the present invention, it is preferable to obtain a resin solution by melt-mixing or solution-mixing 5 to 95 mol % of the dihydrobenzoxazine ring-containing compound (a) and 95 to 5 mol % of the compound (b) reactive with a phenolic hydroxyl group formed by opening of a dihydrobenzoxazine ring, based on the functional groups of each compound. Melt mixing is preferably carried out at 80 to 200° C., and more preferably at 120 to 150° C. The solvent for use in solution mixing is not limited as long as it is compatible with the above compounds (a) and (b), and preferably an alcoholic solvent such as methanol or ethanol; an ethereal solvent such as diethyl ether; a ketonic solvent such as methyl ethyl ketone, acetone or methyl isobutyl ketone; an ester solvent such as ethyl acetate; an aromatic hydrocarbon solvent such as toluene or xylene; a nitrile solvent such as acetonitrile; a chlorinated solvent such as dichloromethane or chloroform; or the like. The amounts of components (a) and (b) are more preferably 10 to 90 mol % of component (a) and 90 to 10 mol % of component (b), and still more preferably 20 to 80 mol % of component (a) and 80 to 20 mol % of component (b). As used herein, mol % is based on the amount of functional groups in component (a) or (b).

The thermosetting resin (A) for use in the present invention is obtained by adding the latent curing agent (c) to the resin solution thus prepared. The thermosetting resin (A) may be, after cooling or solvent distillation, pulverized to obtain a resin powder. The amount of the latent curing agent to be added is preferably 0.1 to 30 parts by weight, and more preferably 0.5 to 20 parts by weight, per 100 parts by weight of components (a) and (b) combined. When the amount of the latent curing agent is less than 0.1 parts by weight, it is likely that the curing takes place at a low rate and thus requires a high temperature and long period of time. More than 30 parts by weight of the latent curing agent, when used, is likely to reduce the heat resistance, mechanical strength and the like of the cured product.

When the thermosetting resin (A) comprising the dihydrobenzoxazine ring-containing compound (a), the compound (b) reactive with a phenolic hydroxyl group formed by opening of a dihydrobenzoxazine ring, and the latent curing agent (c) is cured at a low temperature in a short period of time, the separator can be obtained with improved productivity and at reduced cost. For that purpose, a novolac type phenol resin may, for example, be added to the thermosetting resin (A).

An electroconductive material (B) is added to the thermosetting resin (A) thus obtained, to give an electroconductive resin composition.

The electroconductive material (B) for use in the present invention is not limited. Examples of usable materials include graphites, carbon blacks (Ketjen black, acetylene black, furnace black, oil furnace black, thermal black, etc.), carbon whiskers, amorphous carbons, carbon fibers (PAN-based carbon fibers, pitch-based carbon fibers, carbon fibers prepared from phenol resin fibers, rayon-based carbon fibers, vapor deposited carbon fibers, etc.), carbon short fibers, glassy carbons, metal fibers such as stainless steel, iron, copper, brass, aluminium and nickel fibers, electroconductive polymer fibers such as polyacethylene, polyphenylene, polypyrrole, polythiophene, polyaniline and polyacene fibers, inorganic or organic fibers vapor-deposited or plated with metal, metal powders such as stainless steel, titanium oxide, ruthenium oxide, indium oxide, aluminium, iron, copper, gold, silver, platinum, titanium, nickel, magnesium, palladium, chromium, tin, tantalum and niobium powders, powders of alloys of such metals, etc. Also usable are electroconductive ceramics based on: metal suicides such as iron silicide, molybdenum silicide, zirconium silicide, titanium silicide, etc.; metal carbides such as tungsten carbide, silicon carbide, calcium carbide, zirconium carbide, tantalum carbide, titanium carbide, niobium carbide, molybdenum carbide, vanadium carbide, etc.; metal borides such as tungsten boride, titanium boride, tantalum boride, zirconium boride, etc.; and metal nitrides such as chromium nitride, aluminium nitride, molybdenum nitride, zirconium nitride, tantalum nitride, titanium nitride, gallium nitride, niobium nitride, vanadium nitride, etc; boron nitride; and the like. Electroconductive ceramics such as perovskite type oxides can also be used. These can be used singly or in combination. Among the above electroconductive materials, graphites, carbon blacks and carbon fibers are preferable, and graphites are especially preferable.

The graphite for use in the present invention is not limited. Examples of usable graphites include flake or earthy natural graphite, kish graphite, pyrolytic graphite and artificial graphites. Also usable are expanded graphites obtained by oxidative treatment of such graphites with concentrated sulfuric acid, nitric acid or like oxidizing agent, followed by washing with water and heating; graphitized products such as mesocarbon microbeads, mesophase pitch powders, isotropic pitches; granular graphites obtained by adding a binder to flake graphite, kneading the mixture and forming granules of a predetermined shape, followed by drying or baking; spherical graphites whose shape is controlled by pulverization processing; etc. Further, graphite fluoride, graphite intercalated compounds obtained by intercalating halogen atoms or halogen compounds, carbon nanotubes, carbon nanofibers, carbon nanohorns, fullerenes, etc. are also usable. Among the above graphites, expanded graphites, flake graphites, artificial graphites and carbon nanotubes are preferable. As artificial graphites, those prepared using needle coke as the starting material are preferable.

A pulverized product or cutting powder of a graphite material can also be used as the graphite. The pulverized product or cutting powder of a graphite material is not limited as long as it is graphitic. Preferred examples include pulverized products or cutting powders of graphite materials for use in recarburizers for iron and steel applications, electrodes for electrical discharge machining, dies for continuous casting, electrolytic electrodes, electrodes for steel manufacturing, electrolytic plates, semiconductor fabrication tools, members for silicon single crystal production, mold materials, molds for metals, members for high temperature furnaces, etc. Further, graphite powders generated during machining of graphite materials and usually discarded, and pulverized products of defective graphite materials can also be used. Among these pulverized products and cutting powders of graphite materials, preferable are those for use in recarburizers for iron and steel applications, electrodes for electrical discharge machining, electrolytic plates, semiconductor fabrication tools, members for silicon single crystal production, molds for metals, and members for high temperature furnaces.

The above graphites can be used singly or in combination.

The mean particle diameter of the graphite for use in the present invention is not limited, but considering the miscibility with resins and moldability, the mean particle diameter is preferably 150 μm or less, and more preferably 5 to 100 μm.

The proportions of the thermosetting resin (A) and electroconductive material (B) are preferably 1 to 50 wt. % of the thermosetting resin (a+b+c) and 99 to 50 wt. % of the electroconductive material; more preferably 5 to 35 wt. % of the thermosetting resin (a+b+c) and 95 to 65 wt. % of the electroconductive material; and particularly preferably 10 to 30 wt. % of the thermosetting resin (a+b+c) and 90 to 70 wt. % of the electroconductive material. When the proportion of the thermosetting resin is over 50 wt. %, the resulting separator is likely to have a low electroconductivity, whereas if the proportion is less than 1 wt. %, the separator is likely to have a high gas permeability and a low mechanical strength.

The process for mixing the thermosetting resin (A) and electroconductive material (B) is not limited, and may be, for example, solution blending or dry blending. A solution blending process comprises adding an electroconductive material such as a graphite to a solution of a thermosetting resin in a solvent, thoroughly mixing the mixture in a Henschel mixer or the like, drying (removing the solvent from) the mixture, and pulverizing the resulting mixture to an optimum size. The solvent for use in the solution blending process is not limited as long as it dissolves the thermosetting resin. Preferred solvents include alcoholic solvents such as methanol, ethanol, etc.; ethereal solvents such as diethyl ether and the like; ketonic solvents such as methyl ethyl ketone, acetone, methyl isobutyl ketone, etc.; ester solvents such as ethyl acetate and the like; aromatic hydrocarbon solvents such as toluene, xylene, etc.; nitrile solvents such as acetonitrile and the like; and chlorinated solvents such as dichloromethane, chloroform, etc. A dry blending process is a very easy and simple process which comprises mixing the electroconductive material such as a graphite with the thermosetting resin in powder form, using rolls, an extruder, a Banbury mixer, a V-blender, a kneader, a ribbon mixer, a Henschel mixer or the like. When the dry blending process is employed, in order to increase the miscibility of the thermosetting resin with the electroconductive material, the thermosetting resin preferably has a mean particle diameter of 1 to 1000 μm, and more preferably 5 to 500 μm. When the mean particle diameter of the thermosetting resin is over 1000 μm, the miscibility with the electroconductive material is likely to be low, whereas a thermosetting resin with a mean diameter of less than 1 μm is liable to be aggregated. In both solution blending and dry blending processes, the mixing temperature is preferably a temperature at which the thermosetting resin is not cured, or a temperature at which melting or curing proceeds only slightly, i.e., 0 to 100° C., and more preferably room temperature to 80° C. In view of the cost and workability, a dry blending process is preferable.

The electroconductive resin composition obtained by solution-blending or dry-blending the thermosetting resin (A) with the electroconductive material (B) is cured by heating in a mold of a predetermined shape. The curability of the composition varies depending on the type and amount of the latent curing agent used, the temperature and manner of heating, etc. The composition can be cured rapidly or extremely slowly. In any case, the composition can be completely cured by adjusting the curing temperature and time.

The process for producing the fuel cell separator of the present invention is not limited. For example, the electroconductive resin composition obtained by mixing the thermosetting resin (A) with the electroconductive material (B) may be placed as it is in a mold having a shape as necessary for forming oxidant gas supply channels, fuel gas supply channels, manifolds and other parts of a fuel cell separator, and then heat-cured by compression molding. Alternatively, the electroconductive resin composition may be compressed at a temperature at which the composition is not cured, to form tablets, which are then heat-cured by compression molding in a mold of a predetermined shape.

The fuel cell separator of the present invention can also be produced by multi-daylight pressing, injection molding or transfer molding to improve the productivity. To improve the productivity, while adjusting the molding time to several seconds to several minutes, a predetermined number of moldings may be first prepared and removed from the mold, and then all the moldings may be simultaneously heat-cured in an oven. Further, when molding the separator of the present invention, members necessary for a separator can be integrally molded from the electroconductive resin composition for incorporation of such members into the separator. To date, it has been thought difficult to produce fuel cell separators by transfer molding or injection molding, since the large amount of electroconductive material, such as a graphite, used to impart the required electroconductivity reduces flowability. The fuel cell separator of the present invention can be produced by the above molding processes, and therefore is not only inexpensive but also high in strength, free of warping, and excellent in dimensional stability and thickness accuracy.

In the above molding processes, the curing temperature is preferably 80 to 220° C., and more preferably 100 to 200° C. The curing time is preferably 30 seconds to 4 hours, more preferably 30 seconds to 2 hours, and particularly preferably 30 seconds to 1 hour. The molding pressure is preferably 5 to 60 MPa, and more preferably 10 to 50 MPa.

The thus obtained fuel cell separator of the present invention has a helium permeability, as measured according to JIS K 7126, Method A, of 30 cm³/m²·24 h·atm or less, preferably 20 cm³/m²·24 h·atm or less, and more preferably 0.1 to 10 cm³/m²·24 h·atm; a resistivity, as measured according to JIS R 7222, of 30 mΩ·cm or less, preferably 20 mΩ·cm or less, and more preferably 0.1 to 15 mΩ·cm; a flexural strength, as measured according to JIS K 7203, of 30 to 100 MPa, preferably 30 to 90 MPa; and a flexural modulus, as measured according to JIS K 7203, of 3 to 60 GPa, preferably 10 to 50 GPa.

The fuel cell separator of the present invention can be used in fuel cells as power sources for portable devices, such as cellular phones and notebook PCs, cars, and homes. In addition, it can be used in fuel cells as power sources for artificial satellites and space development, power sources for use in campsites, and power sources for transportation means such as aircraft and watercraft. In accordance with the intended use, various fillers can be added before curing. Examples of usable fillers include organic powders such as wood flours, pulp powders, pulverized fabrics, pulverized products of cured thermosetting resins, etc.; powders or grains of inorganic matters such as silica, aluminium hydroxide, talc, clay, mica, calcium carbonate, barium sulfate, clay mineral, alumina, silica sand, glass, etc.; and rubbers such as silicone rubbers, acrylonitrile-butadiene rubbers, ethylene-butadiene rubbers, urethane rubbers, acrylic rubbers, natural rubbers, butadiene rubbers, etc. The amount of filler can be suitably selected, and is preferably 20 wt. % or less, and more preferably 15 wt. % or less, with respect to the electroconductive resin composition. Also usable as fillers other than the electroconductive material are reinforcing fiber materials such as paper, glass fibers, phenol resin fibers, aramid fibers, polyester fibers, nylon fibers, silicon carbide fibers, ceramic fibers, etc. The amount of reinforcing fiber material to be used can be suitably selected, and is preferably 30 wt. % or less, and more preferably 20 wt. % or less, with respect to the electroconductive resin composition. Further, in order to improve moldability, durability, weatherability, water resistance and other properties, additives such as mold release agents, thickeners, lubricants, UV stabilizers, antioxidants, flame retardants, hydrophilizing agents, etc. can also be used in amounts that do not impair the properties of the fuel cell separator.

Graphite-like conductive materials are intrinsically hydrophobic and thus have poor wettability with the water generated by the electrode reaction in fuel cells. Therefore, such materials cause the problem of “flooding”, i.e., blocking of gas flow channels on the surface of separators with the generated water. When an electroconductive carbon or like material with hydrophilic functional group(s) is used as at least part of the separator surface, the wettability of the separator surface with water is improved, and thereby generated water can be rapidly discharged from the separator. Thus, use of such material is expected to improve the fuel cell performance. A carbon with hydrophilic functional group(s) can be obtained by, for example, baking treatment in an oxygen-containing oxidizing atmosphere, such as air, at about 400 to 600° C. in a short time; treatment in an ozone atmosphere; plasma treatment in oxygen, air or argon gas; corona discharge treatment; ultraviolet irradiation treatment; immersion treatment in a solution of an acid such as nitric acid, followed by washing with water; or the like. Further, addition of 1 to 50 wt. % of a hydrophilic substance to the electroconductive material also improves the wettability of the separator surface with water, making it possible to rapidly discharge generated water from the separator. Such hydrophilic substance is not limited as long as it is hydrophilic and poorly soluble in water. Examples of usable hydrophilic substances include silicon oxide and aluminum oxide that have, on the surface, a large amount of hydrophilic functional groups such as hydroxyl and carboxyl groups; starch/acrylic acid copolymers, i.e., water-absorbing resins; polyacrylic acid salts; polyvinyl alcohols; ion exchange resins; water-absorbing polysaccharides; etc.

Moreover, by inserting a metal plate into the electroconductive resin composition for use in the present invention before hot molding, a separator can be obtained which is excellent in electroconductivity, gas impermeability and mechanical strength. This separator is difficult to break because of the metal plate incorporated in the electroconductive resin composition, and the metal plate is prevented from corroding since it is covered with the electroconductive resin composition. It is preferable that the electroconductive resin composition is molded to form gas flow channels on the metal plate substrate. The base material of the metal plate is preferably a lightweight metal with high specific strength, such as aluminium, titanium, magnesium or the like; alloys thereof; or stainless steel, copper, nickel, iron, steel, ferritic stainless steel, austenitic stainless steel or the like. Both surfaces of the metal plate may be appropriately roughened by electrolytic etching, chemical etching, ultrasonic honing or shot blasting to firmly adhere the electroconductive resin composition.

By inserting an expanded graphite sheet into the electroconductive resin composition in a manner similar to the metal plate before hot molding, a separator can be obtained which is excellent in electroconductivity, gas impermeability and mechanical strength. This separator is difficult to break because of the expanded graphite sheet incorporated in the electroconductive resin composition. It is preferable that the electroconductive resin composition be molded to form gas flow channels on the expanded graphite sheet.

A fuel cell separator can be also obtained by compression-molding the electroconductive material alone, impregnating the molding with the thermosetting resin for use in the present invention to fill the voids in the molding, and heat-curing the resin. The impregnation can be performed by a solvent impregnation process comprising dissolving the thermosetting resin (A) in a solvent, impregnating the molding with the solution, drying (removing the solvent from) the impregnated molding, and heat-curing the resin; a melt impregnation process comprising melting the thermosetting resin (A), impregnating the molding with the resin, and heat-curing the resin; or similar process. The solvent for use in the solvent impregnation process is not limited as long as it dissolves the thermosetting resin. Preferable solvents include alcoholic solvents such as methanol, ethanol, etc.; ethereal solvents such as diethyl ether and the like; ketonic solvents such as methyl ethyl ketone, acetone, methyl isobutyl ketone, etc.; ester solvents such as ethyl acetate and the like; aromatic hydrocarbon solvents such as toluene, xylene, etc.; nitrile solvents such as acetonitrile and the like; and chlorinated solvents such as dichloromethane, chloroform, etc. In a melt impregnation process, the temperature of melt impregnation with the thermosetting resin is preferably 60 to 170° C., and more preferably 80 to 150° C.

Further, the resin component of the molding obtained by hot-molding the electroconductive resin composition may be baked for carbonization or graphitization to thereby obtain a fuel cell separator excellent in mechanical strength and electroconductivity. The baking is performed in an inert gas atmosphere, such as nitrogen, helium, argon or the like, at preferably 800° C. or higher, and more preferably 1500° C. or higher.

Generally, fuel cell separators are required to have high thickness accuracy. This is because, since separators are contacted with electrodes to conduct electricity, poor thickness accuracy decreases the contact area between separators or between a separator and an electrode, thereby increasing the contact resistance and reducing the electroconductivity. In addition, poor thickness accuracy results in gaps between separators or between a separator and an electrode, and thereby the separators may be distorted and broken when fastened with bolts. Namely, the higher the separator thickness accuracy is, the smaller the contact resistance becomes and the less likely the separator is broken, i.e., the more is improved the performance of the fuel cell. Since the fuel cell separator of the present invention can be produced by transfer molding or injection molding, high thickness accuracy can be imparted to the separator. The thus obtained separator of the present invention can provide a fuel cell improved in electroconductivity, mechanical strength and other performance characteristics, as compared with fuel cells produced using hitherto known separators.

Furthermore, fuel cell separators are required to have a uniform density distribution as well as thickness accuracy. This is because density irregularities make the electric resistance (contact resistance) locally high, thereby influencing the current flow and temperature distribution in the fuel cell, and thus may lead to a decrease in power generation efficiency and lifetime of the fuel cell. The fuel cell separator of the present invention has a uniform density distribution regardless of the molding process, and therefore provides a fuel cell that is improved in electroconductivity, mechanical strength and other performance characteristics.

In order to obtain a fuel cell separator that further decreases the contact resistance in the fuel cell, improves the power generation efficiency and is excellent in durability and resistance to corrosion, an electroconductive coating may be formed on at least part of the separator surface that is in contact with an electrode. An electroconductive coating may be formed using carbon graphite, titanium, chromium, a platinum group metal or oxide thereof, tantalum carbide, titanium nitride, titanium carbide, titanium carbide-nitride, aluminum titanium nitride, silicon carbide, an electroconductive polymer or the like. The process for forming the coating may be sputtering, deposition, plating, paste coating or the like. Further, the above-mentioned electroconductive material, such as a graphite powder, may be adhered to the inner surface of the mold before molding the electroconductive resin composition, to form an electroconductive layer such as a graphite layer on the separator surface. In this case, the electroconductive material adhered to the mold surface improves the mold releasability, and the electroconductive layer formed on the separator surface decreases the contact resistance between the separators or between the separator and an electrode and improves the corrosion resistance and durability.

The fuel cell separator of the present invention can be used as a separator for various fuel cells including polymer electrolyte, phosphoric acid, molten carbonate, solid oxide and like fuel cells. In particular, the separator of the present invention is suitable as a separator for a polymer electrolyte fuel cell.

The fuel cell separator of the present invention is extremely excellent in terms of gas impermeability, electroconductivity, mechanical strength and lightweight properties, and retains such performance characteristics stably for a long period of time. Further, since the thermosetting resin for use in the present invention does not generate volatiles such as formaldehyde, condensation water, ammonia gas or the like during the curing reaction, the resin has good moldability and is capable of inexpensively giving a fuel cell separator excellent in electroconductivity, gas impermeability, mechanical strength and dimensional stability. Furthermore, the fuel cell separator of the present invention can be quickly molded and therefore produced with high productivity and at greatly reduced cost. Moreover, the separator of the present invention can be produced by not only the typically employed compression molding, but also transfer molding or injection molding, which improves productivity and is capable of giving a high-performance fuel cell separator with excellent thickness accuracy and without density irregularities. Use of the separator of the present invention also improves the power generation characteristics of a fuel cell.

### BRIEF DESCRIPTION OF THE DRAWINGS

FIG. 1 is a schematic diagram showing an example of a fuel cell separator.

FIG. 2 is a graph showing the power generation characteristics of a fuel cell.

### BEST MODE FOR CARRYING OUT THE INVENTION

The following Examples and Comparative Examples illustrate the present invention in further detail.

The compounds used in the Examples and Comparative Examples are the following.

The 2,2-bis(3,4-dihydro-3-phenyl-1,3-benzoxazine)propane (hereinafter “B-a”; molecular weight: 462) and 2,2-bis(3,4-dihydro-3-phenyl-1,3-benzoxazine)methane (hereinafter “F-a”; molecular weight: 434), which have two dihydrobenzoxazine rings in the molecule, were products of Shikoku Corp. (B-a and F-a being compounds represented by formula (5)). The phenol novolac was Phenolite TD2131 manufactured by Dainippon Ink and Chemicals, Inc. 1,3-Bis(2-oxazoline-2-yl)benzene (CP Resin manufactured by Mikuni Pharmaceutical Industrial Co., Ltd.; hereinafter “1,3-PBO”) was used as the 2-oxazoline compound (component (b)). The epoxy resins (components (b)) used were Bisphenol A diglycidyl ether (Epikote 828 manufactured by Japan Epoxy Resins Co., Ltd.; epoxy equivalent: 190; hereinafter “DGEBA”) and o-cresol novolac epoxy resin (EPICLON N-665 manufactured by Dainippon Ink and Chemicals, Inc.; epoxy equivalent: 211; hereinafter “OCNE”). The phenol resins used in the Comparative Examples were PL-2211 (a resol type phenol resin manufactured by Gunei Chemical Industry Co., Ltd.; hereinafter “PL”) and Phenolite TD2131 (a novolac type phenol resin manufactured by Dainippon Ink and Chemicals, Inc.; hereinafter “N1”). The hexamethylenetetramine used as the curing agent for N1 was a commercially available reagent.

The graphites used in the Examples and Comparative Examples are the following.

The graphite powders used were a powder (mean particle diameter: about 30 um; hereinafter “GE-134”) obtained by pulverizing, with a belt sander (endless paper), Escaphite GE-134 (Shinnikka Techno-Carbon Co., Ltd.) for use as an artificial graphite product for electrical, metallurgical and chemical applications such as electrolytic plates, molds for metals and high temperature furnace members; a powder (mean particle diameter: about 20 μm; hereinafter “TKC”) obtained by pulverizing, in a ball mill, TKC Raisers (Shinnikka Techno-Carbon Co., Ltd.) for use as a recarburizer for steel and iron applications; and an expanded graphite BSP-2 manufactured by Chuetsu Graphite Works Co., Ltd. (average particle size: about 45 um; hereinafter “BSP-2”) and a flake graphite CBR manufactured by Chuetsu Graphite Works Co., Ltd. (average particle size: about 18 um; hereinafter “CBR”).

In the Examples and Comparative Examples, the following test standards and conditions were employed to evaluate the properties.

1. Gas Permeability Test

Using circular test pieces (1 mm thickness, 100 mm diameter), the helium (He) permeability was measured at 1 atm and 23° C. according to JIS K 7126, Method A.

2. Resistivity Measurement

The resistivity was measured by the fall-of-potential method according to JIS R 7222.

3. Bending Test

Rectangular test pieces (60 mm length, 15 mm width, 1 mm thickness) were subjected to the three-point bending test according to JIS K 7203, at room temperature and at a test speed of 1 mm/min with a support distance of 40 mm, to measure the flexural strength and flexural modulus.

4. Density Measurement

The density was measured according to JIS K 7112, Method A (underwater replacement method).

5. Density difference

The density was measured at eight specific points of each of two samples molded from the same resin composition. The difference between the highest and lowest density values in each sample was found, and the average of the two difference values found in the two samples was indicated as the density difference.

6. Thickness Accuracy

The thickness was measured using a micrometer at five points of each of five samples molded from the same resin composition. The difference between the highest and lowest thickness values in each sample was found, and the average of the five difference values found in the five samples was indicated as the thickness accuracy (1). Further, in respect of the 25 thickness values (five points×five samples), the difference between the highest and lowest thickness values overall was indicated as the thickness accuracy (2).

7. Power Generation Characteristics of Fuel Cells (Current-Voltage)

Using HZ-3000, an electrochemical measurement system manufactured by Hokuto Denko Ltd., current-voltage measurements were carried out at a hydrogen flow rate of 200 ml/min and an oxygen flow rate of 200 ml/min at room temperature to evaluate the power generation characteristics of fuel cells.

### SYNTHESIS EXAMPLE 1

### Synthesis of Dihydrobenzoxazine Compound

A flask was charged with 1,4-dioxane and 2 mol of 37% formalin. While maintaining the mixture at 5° C. or less, 1 mol of aniline (a 1,4-dioxane solution) was added dropwise with stirring. Further, 1 mol of phenol novolac (a 1,4-dioxane solution) was added dropwise in the same manner. After completion of the addition, the resulting mixture was heated to reflux, and the reaction was continued for 6 hours at the same temperature. The solvent was then distilled off to thereby obtain a phenol novolac type dihydrobenzoxazine compound in which about 90% of the phenolic hydroxyl groups had been converted to dihydrobenzoxazine (a compound of formula (7); hereinafter “N1-a”).

### PREPARATION EXAMPLE 1

### Preparation of Reaction Product of Alkanolamine with p-toluenesulfonic Acid (Curing Agent)

p-Toluenesulfonic acid (9.5 g (0.05 mol)) was added at room temperature to 5.26 g (0.05 mol) of diethanolamine or 3.8 g (0.05 mol) of isopropanolamine, to carry out reactions (hereinafter the reaction product of diethanolamine with p-toluenesulfonic acid being referred to as “cat. 1”, and the reaction product of isopropanolamine with p-toluenesulfonic acid as “cat. 2”).

### EXAMPLES 1 TO 8

B-a or N1-a as a dihydrobenzoxazine compound (component a), 1,3-PBO, DGEBA or OCNE as a compound reactive with a phenolic hydroxyl group formed by opening of a dihydrobenzoxazine ring (component b), and cat. 1 or cat. 2 as a latent curing agent (component c) were melt-mixed at 130° C. in the ratios specified in Table 1, to obtain thermosetting resins. Specifically, equimolar amounts of components a and b were melt-mixed, and 10 parts by weight of component c was added to 100 parts by weight of components a and b combined. Thereafter, the thermosetting resin (a+b+c) and a graphite (GE-134) as an electroconductive material were mixed in a weight ratio of 20:80, solution-blended in acetone and thoroughly mixed in a mixer. The acetone was removed, and the resulting electroconductive resin composition was pulverized, tableted at room temperature, and compression-molded in a mold at 170° C. and 30 MPa for 10 minutes, to thereby obtain 1 mm-thick carbon moldings for use as fuel cell separators. The carbon moldings were subjected to the gas permeability test, resistivity measurement, bending test and density measurement. Table 1 shows the results.

### COMPARATIVE EXAMPLE 1

A resol type phenol resin (PL) and a graphite (GE-134) as an electroconductive material were mixed in a weight ratio of 20:80, solution-blended in methanol and thoroughly mixed in a mixer. The methanol was removed, and the resulting electroconductive resin composition was pulverized, tableted at room temperature, and compression-molded in a mold at 170° C. and 30 MPa for 10 minutes, to thereby obtain 1 mm-thick carbon moldings for use as fuel cell separators. The carbon moldings were subjected to the gas permeability test, resistivity measurement, bending test and density measurement. Table 1 shows the results.

TABLE 1

| | | | | | | | | | | | Comp. |
|---|---|---|---|---|---|---|---|---|---|---|---|
| | | | Example | | | | | | | | Ex. |
| | | | 1 | 2 | 3 | 4 | 5 | 6 | 7 | 8 | 1 |
| Thermosetting resin | (a) Dihydro- | B-a | 50 | 50 | 50 | 50 | | | | | |
| | benzoxazine (mol %) | N1-a | | | | | 50 | 50 | 50 | 50 | |
| | (b) Reactant | 1,3-PBO | 50 | 50 | | | 50 | 50 | | | |
| | compound (mol %) | DGEBA | | | 50 | | | | 50 | | |
| | | OCNE | | | | 50 | | | | 50 | |
| | (c) Curing agent | 1) Diethanolamine- | 10 | | | | 10 | | | | |
| | (wt. parts) | p-toluenesulfonic | | | | | | | | | |
| | | acid (cat. 1) | | | | | | | | | |
| | | 2) Isopropanolamine- | | 10 | 10 | 10 | | 10 | 10 | 10 | |
| | | p-toluenesulfonic | | | | | | | | | |
| | | acid (cat. 2) | | | | | | | | | |

| | | | | | | | | | | |
|---|---|---|---|---|---|---|---|---|---|---|
| ECRC | Thermosetting resin (a) + (b) + (c) (wt. %) | 20 | 20 | 20 | 20 | 20 | 20 | 20 | 20 | |
| | Phenol resin PL (wt. %) | | | | | | | | | 20 |
| | Graphite (GE-134) (wt. %) | 80 | 80 | 80 | 80 | 80 | 80 | 80 | 80 | 80 |
| Properties | Helium permeability (cm³/m² · 24 h · atm) | 7.0 | 4.4 | 4.2 | 4.4 | 3.9 | 4.4 | 3.8 | 3.5 | >10000 |
| | Resistivity (mΩ · cm) | 5.7 | 6.0 | 6.2 | 5.9 | 5.3 | 5.4 | 6.0 | 6.0 | 8.2 |
| | Flexural strength (MPa) | 75 | 73 | 72 | 72 | 77 | 77 | 72 | 72 | 55 |
| | Flexural modulus (GPa) | 21 | 18 | 17 | 18 | 20 | 19 | 17 | 18 | 17 |
| | Density (g/cm³) | 1.91 | 1.90 | 1.89 | 1.89 | 1.93 | 1.92 | 1.90 | 1.91 | 1.92 |

ECRC: Electroconductive resin composition

### EXAMPLES 9 TO 15

Equimolar amounts of B-a as a dihydrobenzoxazine compound (component a) and 1,3-PBO as a compound reactive with a phenolic hydroxyl group formed by opening of a dihydrobenzoxazine ring (component b) were melt-mixed at 130° C. Ten parts by weight of cat. 1 as a latent curing agent (component c) was added to 100 parts by weight of components a and b combined, to thereby obtain a thermosetting resin. The thermosetting resin and a graphite (GE-134, TKC, BSP-2 or CBR) were mixed in the weight ratios specified in Table 2, solution-blended in acetone and thoroughly mixed in a mixer. The acetone was removed, and the resulting electroconductive resin composition was pulverized, tableted at room temperature, and compression-molded in a mold at 170° C. and 30 MPa for 10 minutes to obtain 1 mm-thick carbon moldings for use as fuel cell separators. The carbon moldings were subjected to the gas permeability test, resistivity measurement, bending test and density measurement. Table 2 shows the results.

### COMPARATIVE EXAMPLES 2 TO 4

A resol type phenol resin (PL) and a graphite (TKC, BSP-2 or CBR) were mixed in the weight ratios shown in Table 2, solution-blended in methanol and thoroughly mixed in a mixer. The methanol was removed, and the resulting electroconductive resin composition was pulverized, tableted at room temperature, and compression-molded in a mold at 170° C. and 30 MPa for 10 minutes to obtain 1 mm-thick carbon moldings for use as fuel cell separators. The carbon moldings were subjected to the gas permeability test, resistivity measurement, bending test and density measurement. Table 2 shows the results.

For reference, Table 2 also shows the results of Example 1 and Comparative Example 1.

TABLE 2

| | | | Example | | | | | | | | Comp. Ex. | | | |
|---|---|---|---|---|---|---|---|---|---|---|---|---|---|---|
| | | | 1 | 9 | 10 | 11 | 12 | 13 | 14 | 15 | 1 | 2 | 3 | 4 |
| ECRC | Thermosetting resin | | 20 | 15 | 20 | 15 | 20 | 15 | 20 | 15 | | | | |
| | B-a + 1,3-PBO + cat. 1 | | | | | | | | | | | | | |
| | (wt. %) | | | | | | | | | | | | | |
| | Phenol resin PL (wt. %) | | | | | | | | | | 20 | 20 | 20 | 20 |
| | Graphite | 1) GE-134 | 80 | 85 | | | | | | | 80 | | | |
| | (wt. %) | 2) TKC | | | 80 | 85 | | | | | | 80 | | |
| | | 3) BSP-2 | | | | | 80 | 85 | | | | | 80 | |
| | | 4) CBR | | | | | | | 80 | 85 | | | | 80 |

| | | | | | | | | | | | | | |
|---|---|---|---|---|---|---|---|---|---|---|---|---|---|
| Properties | Helium permeability | 7.0 | 9.8 | 9.4 | 9.5 | 4.6 | 4.0 | 5.2 | 5.0 | * | * | 5.2 | 5.5 |
| | (cm³/m² · 24 h · atm) | | | | | | | | | | | | |
| | Resistivity (mΩ · cm) | 5.7 | 4.3 | 9.7 | 6.6 | 4.2 | 2.2 | 10.7 | 5.2 | 8.2 | 16.0 | 4.5 | 13.7 |
| | Flexural strength (MPa) | 75 | 66 | 63 | 62 | 87 | 91 | 69 | 74 | 55 | 62 | 75 | 58 |
| | Flexural modulus (GPa) | 21 | 20 | 16 | 17 | 41 | 41 | 35 | 40 | 17 | 15 | 35 | 27 |
| | Density (g/cm³) | 1.91 | 1.93 | 1.91 | 1.96 | 1.91 | 1.98 | 1.93 | 2.00 | 1.92 | 1.92 | 1.93 | 1.95 |

ECRC: Electroconductive resin composition
* >10000

### EXAMPLES 16 TO 22

Equimolar amounts of B-a as a dihydrobenzoxazine compound (component a) and 1,3-PBO as a compound reactive with a phenolic hydroxyl group formed by opening of a dihydrobenzoxazine ring (component b) were melt-mixed at 130° C. Ten parts by weight of cat. 1 as a latent curing agent (component c) was added to 100 parts by weight of components a and b combined, and the mixture was cooled and pulverized to obtain a thermosetting resin powder. The thermosetting resin powder and a graphite (GE-134, TKC, BSP-2 or CBR) were dry-blended in the weight ratios shown in Table 3 and thoroughly mixed in a mixer. The obtained electroconductive resin composition was tableted at room temperature and compression-molded in a mold at 170° C. and 30 MPa for 10 minutes to obtain 1 mm-thick carbon moldings for use as fuel cell separators. The carbon moldings were subjected to the gas permeability test, resistivity measurement, bending test and density measurement. Table 3 shows the results.

### COMPARATIVE EXAMPLES 5 TO 8

Ten parts by weight of hexamethylenetetramine as a curing agent was added to 100 parts by weight of a phenol novolac type phenol resin (N1) to obtain an ordinary phenol resin composition. The phenol resin composition and a graphite (GE-134, TKC, BSP-2 or CBR) as an electroconductive material were dry-blended in a weight ratio of 20:80 and thoroughly mixed in a mixer. The obtained electroconductive resin composition was tableted at room temperature and compression-molded in a mold at 170° C. and 30 MPa for 10 minutes to obtain 1 mm-thick carbon moldings for use as fuel cell separators. The carbon moldings were subjected to the gas permeability test, resistivity measurement, bending test and density measurement. Table 3 shows the results.

TABLE 3

| | | | Example | | | | | | | Comp. Ex. | | | |
|---|---|---|---|---|---|---|---|---|---|---|---|---|---|
| | | | 16 | 17 | 18 | 19 | 20 | 21 | 22 | 5 | 6 | 7 | 8 |
| Electroconductive | Thermosetting resin | | 20 | 20 | 15 | 25 | 20 | 20 | 15 | | | | |
| resin composition | B-a + 1,3-PBO + cat. 1 | | | | | | | | | | | | |
| | (wt. %) | | | | | | | | | | | | |
| | Phenol resin N1 + | | | | | | | | | 20 | 20 | 20 | 20 |
| | Hexamethylenetetramine | | | | | | | | | | | | |
| | (wt. %) | | | | | | | | | | | | |
| | Graphite | 1) GE-134 | 80 | | | | | | | 80 | | | |
| | (wt. %) | 2) TKC | | 80 | 85 | | | | | | 80 | | |
| | | 3) BSP-2 | | | | 75 | 80 | | | | | 80 | |
| | | 4) CBR | | | | | | 80 | 85 | | | | 80 |

| | | | | | | | | | | | | |
|---|---|---|---|---|---|---|---|---|---|---|---|---|
| Properties | Helium permeability | 5.3 | 3.7 | 5.2 | 3.5 | 4.6 | 5.1 | 5.3 | 9.8 | 14.3 | 6.2 | 6.8 |
| | (cm³/m² · 24 h · atm) | | | | | | | | | | | |
| | Resistivity (mΩ · cm) | 5.8 | 8.8 | 6.2 | 3.7 | 3.2 | 12.8 | 5.1 | 5.9 | 9.9 | 3.9 | 11.4 |
| | Flexural strength (MPa) | 73 | 68 | 63 | 64 | 83 | 82 | 72 | 61 | 66 | 62 | 59 |
| | Flexural modulus (GPa) | 20 | 17 | 16 | 28 | 37 | 36 | 38 | 20 | 17 | 32 | 35 |
| | Density (g/cm³) | 1.91 | 1.91 | 1.96 | 1.84 | 1.91 | 1.93 | 2.00 | 1.92 | 1.92 | 1.90 | 1.93 |

### EXAMPLES 23 TO 26

Equimolar amounts of F-a as a dihydrobenzoxazine compound (component a) and 1,3-PBO as a compound reactive with a phenolic hydroxyl group formed by opening of a dihydrobenzoxazine ring (component b) were melt-mixed at 130° C. Ten parts by weight of cat. 1 as a latent curing agent (component c) was added to 100 parts by weight of components a and b combined, and the mixture was cooled and pulverized to obtain a thermosetting resin powder. The thermosetting resin powder and a graphite (GE-134, TKC, BSP-2 or CBR) were dry-blended in a weight ratio of 20:80 and thoroughly mixed in a mixer. The obtained electroconductive resin composition was tableted at room temperature and compression-molded in a mold at 170° C. and 30 MPa for 10 minutes to obtain 1 mm-thick carbon moldings for use as fuel cell separators. The carbon moldings were subjected to the gas permeability test, resistivity measurement, bending test and density measurement. Table 4 shows the results.

For reference, Table 4 also shows the results of Comparative Examples 5 to 8.

TABLE 4

| | | | Example | | | | Comp. Ex. | | | |
|---|---|---|---|---|---|---|---|---|---|---|
| | | | 23 | 24 | 25 | 26 | 5 | 6 | 7 | 8 |
| Electroconductive | Thermosetting resin | | 20 | 20 | 20 | 20 | | | | |
| resin composition | F-a + 1,3-PBO + cat. 1 | | | | | | | | | |
| | (wt. %) | | | | | | | | | |
| | Phenol resin N1 + | | | | | | 20 | 20 | 20 | 20 |
| | Hexamethylene- | | | | | | | | | |
| | tetramine (wt. %) | | | | | | | | | |
| | Graphite | 1) GE-134 | 80 | | | | 80 | | | |
| | (wt. %) | 2) TKC | | 80 | | | | 80 | | |
| | | 3) BSP-2 | | | 80 | | | | 80 | |
| | | 4) CBR | | | | 80 | | | | 80 |

| | | | | | | | | | |
|---|---|---|---|---|---|---|---|---|---|
| Properties | Helium permeability | 5.6 | 5.8 | 4.0 | 4.2 | 9.8 | 14.3 | 6.2 | 6.8 |
| | (cm³/m² · 24 h · atm) | | | | | | | | |
| | Resistivity (mΩ · cm) | 5.8 | 8.1 | 2.7 | 10.9 | 5.9 | 9.9 | 3.9 | 11.4 |
| | Flexural strength (MPa) | 72 | 67 | 80 | 74 | 61 | 66 | 62 | 59 |
| | Flexural modulus (GPa) | 21 | 16 | 31 | 36 | 20 | 17 | 32 | 35 |
| | Density (g/cm³) | 1.92 | 1.92 | 1.93 | 1.97 | 1.92 | 1.92 | 1.90 | 1.93 |

### EXAMPLES 27 TO 36

Equimolar amounts of B-a as a dihydrobenzoxazine compound (component a) and 1,3-PBO as a compound reactive with a phenolic hydroxyl group formed by opening of a dihydrobenzoxazine ring (component b) were melt-mixed at 130° C. Ten parts by weight of cat. 1 or cat. 2 as a latent curing agent (component c) was added to 100 parts by weight of components a and b combined, and the mixture was cooled and pulverized to obtain two types of thermosetting resin powders. The two thermosetting resins were separately dry-blended with graphites (TKC and BSP-2) in the weight ratios shown in Table 5 and thoroughly mixed in a mixer. The obtained electroconductive resin compositions were tableted at room temperature and compression-molded in a mold at 170° C. and 30 MPa for 10 minutes to obtain 1 mm-thick carbon moldings for use as fuel cell separators. The carbon moldings were subjected to the gas permeability test, resistivity measurement, bending test and density measurement. Table 5 shows the results.

For reference, Table 5 also shows the results of Comparative Example 6.

TABLE 5

| | | | | | | | | | | | | | Comp. |
|---|---|---|---|---|---|---|---|---|---|---|---|---|---|
| | | | Example | | | | | | | | | | Ex. |
| | | | 27 | 28 | 29 | 30 | 31 | 32 | 33 | 34 | 35 | 36 | 6 |
| Electroconductive | Thermo- | B-a + 1,3-PBO + cat. 1 | 20 | 20 | 20 | 20 | 20 | | 15 | | 15 | | |
| resin composition | setting | B-a + 1,3-PBO + cat. 2 | | | | | | 20 | | 15 | | 15 | |
| | resin | | | | | | | | | | | | |
| | (wt. %) | | | | | | | | | | | | |
| | Phenol resin N1 + | | | | | | | | | | | | 20 |
| | Hexamethylenetetramine | | | | | | | | | | | | |
| | (wt. %) | | | | | | | | | | | | |
| | Graphite | 1) TKC | 75 | 70 | 60 | 50 | 40 | 50 | 50 | 50 | 55 | 55 | 80 |
| | (wt. %) | 2) BSP-2 | 5 | 10 | 20 | 30 | 40 | 30 | 35 | 35 | 30 | 30 | |

| | | | | | | | | | | | | |
|---|---|---|---|---|---|---|---|---|---|---|---|---|
| Properties | Helium permeability | 5.0 | 4.8 | 5.2 | 5.1 | 6.8 | 4.9 | 5.3 | 5.8 | 5.2 | 5.1 | 14.3 |
| | (cm³/m² · 24 h · atm) | | | | | | | | | | | |
| | Resistivity (mΩ · cm) | 8.0 | 7.7 | 7.0 | 5.9 | 5.0 | 7.4 | 3.6 | 4.1 | 3.9 | 4.8 | 9.9 |
| | Flexural strength (MPa) | 66 | 68 | 63 | 73 | 73 | 69 | 73 | 68 | 73 | 66 | 66 |
| | Flexural modulus (GPa) | 18 | 20 | 19 | 23 | 24 | 20 | 22 | 19 | 21 | 19 | 17 |
| | Density (g/cm³) | 1.91 | 1.91 | 1.90 | 1.90 | 1.90 | 1.88 | 1.97 | 1.94 | 1.97 | 1.93 | 1.92 |

### EXAMPLES 37 TO 42

Equimolar amounts of B-a as a dihydrobenzoxazine compound (component a) and 1,3-PBO as a compound reactive with a phenolic hydroxyl group formed by opening of a dihydrobenzoxazine ring (component b) were melt-mixed at 130° C. Ten parts by weight of cat. 1 as a latent curing agent (component c) was added to 100 parts by weight of components a and b combined, and the mixture was cooled and pulverized to obtain a thermosetting resin powder. The thermosetting resin and graphites (BSP-2 and CBR) were dry-blended in the weight ratios shown in Table 6 and thoroughly mixed in a mixer. The obtained electroconductive resin composition was tableted at room temperature and compression-molded in a mold at 170° C. and 30 MPa for 10 minutes to obtain 1 mm-thick carbon moldings for use as fuel cell separators. The carbon moldings were subjected to the gas permeability test, resistivity measurement, bending test and density measurement. Table 6 shows the results.

For reference, Table 6 also shows the results of Comparative Example 8.

TABLE 6

| | | | | | | | | | Comp. |
|---|---|---|---|---|---|---|---|---|---|
| | | | Example | | | | | | Ex. |
| | | | 37 | 38 | 39 | 40 | 41 | 42 | 8 |
| Electroconductive | Thermosetting resin | | 15 | 15 | 20 | 25 | 20 | 25 | |
| resin composition | B-a + 1,3-PBO + cat. 1 | | | | | | | | |
| | (wt. %) | | | | | | | | |
| | Phenol resin N1 + | | | | | | | | 20 |
| | hexamethylenetetramine | | | | | | | | |
| | (wt. %) | | | | | | | | |
| | Graphite | 1) BSP-2 | 10 | 20 | 40 | 55 | 65 | 65 | |
| | (wt. %) | 2) CBR | 75 | 65 | 40 | 20 | 15 | 10 | 80 |

| | | | | | | | | |
|---|---|---|---|---|---|---|---|---|
| Properties | Helium permeability | 4.3 | 4.5 | 4.8 | 3.0 | 3.2 | 3.9 | 6.8 |
| | (cm³/m² · 24 h · atm) | | | | | | | |
| | Resistivity (mΩ · cm) | 5.8 | 4.2 | 4.9 | 5.6 | 3.2 | 4.8 | 11.4 |
| | Flexural strength (MPa) | 78 | 77 | 83 | 78 | 81 | 71 | 59 |
| | Flexural modulus (GPa) | 35 | 39 | 39 | 31 | 30 | 29 | 35 |
| | Density (g/cm³) | 2.00 | 1.78 | 1.93 | 1.87 | 1.91 | 1.85 | 1.93 |

### EXAMPLES 43 TO 50

Equimolar amounts of B-a or F-a as a dihydrobenzoxazine compound (component a) and 1,3-PBO as a compound reactive with a phenolic hydroxyl group formed by opening of a dihydrobenzoxazine ring (component b) were melt-mixed at 130° C. Ten parts by weight of cat. 1 as a latent curing agent (component c) was added to 100 parts by weight of components a and b combined, and the mixture was cooled and pulverized to obtain two types of thermosetting resin powders. The two thermosetting resins were separately dry-blended with a graphite (GE-134, TKC, BSP-2 or CBR) in a weight ratio of 20:80 and thoroughly mixed in a mixer. The obtained electroconductive resin compositions were tableted at room temperature and compression-molded in a mold at 200° C. and 30 MPa for 1 minute to obtain 1 mm-thick carbon moldings for use as fuel cell separators. The carbon moldings were subjected to the gas permeability test, resistivity measurement, bending test and density measurement. Table 7 shows the results.

### COMPARATIVE EXAMPLES 9 TO 12

Ten parts by weight of hexamethylenetetramine as a curing agent was added to 100 parts by weight of a phenol novolac type phenol resin (N1) to obtain an ordinary phenol resin composition. The phenol resin composition and a graphite (GE-134, TKC, BSP-2 or CBR) as an electroconductive material were dry-blended in a weight ratio of 20:80 and thoroughly mixed in a mixer. The obtained electroconductive resin composition was tableted at room temperature and compression-molded in a mold at 200° C. and 30 MPa for 1 minute to obtain 1 mm-thick carbon moldings for use as fuel cell separators. The carbon moldings were subjected to the gas permeability test, resistivity measurement, bending test and density measurement. Table 7 shows the results.

TABLE 7

| | | | Example | | | | | | | | Comp. Ex. | | | |
|---|---|---|---|---|---|---|---|---|---|---|---|---|---|---|
| | | | 43 | 44 | 45 | 46 | 47 | 48 | 49 | 50 | 9 | 10 | 11 | 12 |
| Electroconductive | Thermo- | B-a + 1,3-PBO + cat. 1 | 20 | 20 | 20 | 20 | | | | | | | | |
| resin composition | setting | F-a + 1,3-PBO + cat. 1 | | | | | 20 | 20 | 20 | 20 | | | | |
| | resin | | | | | | | | | | | | | |
| | (wt. %) | | | | | | | | | | | | | |
| | Phenol resin N1 + | | | | | | | | | | 20 | 20 | 20 | 20 |
| | Hexamethylenetetramine | | | | | | | | | | | | | |
| | (wt. %) | | | | | | | | | | | | | |
| | Graphite | 1) GE-134 | 80 | | | | 80 | | | | 80 | | | |
| | (wt. %) | 2) TKC | | 80 | | | | 80 | | | | 80 | | |
| | | 3) BSP-2 | | | 80 | | | | 80 | | | | 80 | |
| | | 4) CBR | | | | 80 | | | | 80 | | | | 80 |

| | | | | | | | | | | | | | |
|---|---|---|---|---|---|---|---|---|---|---|---|---|---|
| Properties | Helium permeability | 4.0 | 5.8 | 3.2 | 5.1 | 4.8 | 5.9 | 3.5 | 5.6 | * | * | 7.0 | 8.2 |
| | (cm³/m² · 24 h · atm) | | | | | | | | | | | | |
| | Resistivity (mΩ · cm) | 6.8 | 9.0 | 2.9 | 9.8 | 6.1 | 9.6 | 2.7 | 9.1 | 7.0 | 15.1 | 4.0 | 10.5 |
| | Flexural strength (MPa) | 61 | 61 | 84 | 76 | 77 | 62 | 86 | 78 | 34 | 42 | 55 | 64 |
| | Flexural modulus (GPa) | 17 | 16 | 34 | 37 | 21 | 15 | 36 | 40 | 12 | 12 | 24 | 34 |
| | Density (g/cm³) | 1.84 | 1.82 | 1.89 | 1.94 | 1.89 | 1.91 | 1.91 | 1.95 | 1.92 | 1.92 | 1.91 | 1.94 |

* >10000

### EXAMPLES 51 TO 58

B-a or N1-a as a dihydrobenzoxazine compound (component a), 1,3-PBO or DGEBA as a compound reactive with a phenolic hydroxyl group formed by opening of a dihydrobenzoxazine ring (component b) and cat. 1 or cat. 2 as a latent curing agent (component c) were melt-mixed at 130° C. in the weight ratios shown in Table 8 to obtain thermosetting resins. Specifically, equimolar amounts of components a and b were melt-mixed, and 10 parts by weight of component c was added relative to 100 parts by weight of components a and b combined. The resulting mixture was cooled and pulverized to thereby obtain five types of thermosetting resin powders. The five thermosetting resins were separately dry-blended with graphites (TKC and BSP-2) in the weight ratios shown in Table 8 and thoroughly mixed in a mixer. The resulting electroconductive resin compositions were tableted at room temperature and compression-molded in a mold at 30 MPa at the molding temperatures and molding times shown in Table 8, to thereby obtain 1 mm-thick carbon moldings for use as fuel cell separators. The carbon moldings were subjected to the gas permeability test, resistivity measurement, bending test and density measurement. Table 8 shows the results.

For reference, Table 8 also shows the results of Comparative Example 10.

TABLE 8

| | | | | | | | | | | | Comp. |
|---|---|---|---|---|---|---|---|---|---|---|---|
| | | | Example | | | | | | | | Ex. |
| | | | 51 | 52 | 53 | 54 | 55 | 56 | 57 | 58 | 10 |
| Thermo- | (a) Dihydro- | B-a | 50 | 50 | 50 | 50 | 50 | 50 | | | |
| setting | benzoxazine (mol %) | N1-a | | | | | | | 50 | 50 | |
| resin | (b) Reactant | 1,3-PBO | 50 | | 50 | 50 | 50 | 50 | 50 | 50 | |
| | compound (mol %) | DGEBA | | 50 | | | | | | | |
| | (c) Curing | 1) Diethanolamine-p- | 10 | | 10 | | | | 10 | | |
| | agent | toluenesulfonic acid | | | | | | | | | |
| | | (cat. 1) | | | | | | | | | |
| | (wt. parts) | 2) Isopropanolamine-p- | | 10 | | 10 | 10 | 10 | | 10 | |
| | | toluenesulfonic acid | | | | | | | | | |
| | | (cat. 2) | | | | | | | | | |
| ECRC | Thermosetting resin (a) + (b) + (c) (wt. %) | | 20 | 20 | 20 | 20 | 20 | 20 | 20 | 20 | |
| | Phenol resin N1 + hexamethylenetetramine | | | | | | | | | | 20 |
| | (wt. %) | | | | | | | | | | |
| | Graphite | 1) TKC | 50 | 50 | 40 | 40 | 40 | 40 | 40 | 40 | 80 |
| | (wt. %) | 2) BSP-2 | 30 | 30 | 40 | 40 | 40 | 40 | 40 | 40 | |

| | | | | | | | | | | |
|---|---|---|---|---|---|---|---|---|---|---|
| | Molding temperature (° C.) | 170 | 170 | 200 | 180 | 190 | 200 | 200 | 200 | 200 |
| | Molding time (min) | 5 | 5 | 1 | 1 | 1 | 0.5 | 0.5 | 0.5 | 1 |
| Properties | Helium permeability (cm³/m² · 24 h · atm) | 5.3 | 4.9 | 3.9 | 4.8 | 5.2 | 5.5 | 4.3 | 3.8 | * |
| | Resistivity (mΩ · cm) | 5.6 | 7.7 | 5.4 | 7.0 | 7.5 | 6.4 | 5.9 | 5.6 | 15.1 |
| | Flexural strength (MPa) | 70 | 70 | 78 | 74 | 73 | 67 | 74 | 76 | 42 |
| | Flexural modulus (GPa) | 20 | 18 | 24 | 22 | 22 | 21 | 23 | 24 | 12 |
| | Density (g/cm³) | 1.91 | 1.88 | 1.91 | 1.88 | 1.88 | 1.89 | 1.91 | 1.91 | 1.92 |

ECRC: Electroconductive resin composition
* >10000

### EXAMPLES 59 TO 85

The electroconductive resin compositions obtained in Examples 1 to 8, 12 to 16, 19 to 26 and 37 to 42 were transfer-molded (mold clamping pressure: 20 MPa, injection pressure: 10 MPa) at 170° C. for 10 minutes to obtain 3 mm-thick carbon moldings for use as fuel cell separators. The carbon moldings had particularly excellent thickness accuracy and uniform density distribution, and were remarkably excellent in mechanical strength, electroconductivity and gas impermeability. Table 9 shows the results of Examples 71, 72, 73, 75, 84 and 85 as representative examples.

### COMPARATIVE EXAMPLES 13 TO 18

Ten parts by weight of hexamethylenetetramine was added as a curing agent to 100 parts by weight of a phenol novolac type phenol resin (N1) to obtain an ordinary phenol resin composition. The phenol resin composition was dry-blended with graphite(s) (GE-134, BSP-2, CBR) as an electroconductive material in the weight ratios shown in Table 9 and then thoroughly mixed in a mixer. The obtained electroconductive resin composition was transfer-molded (mold clamping pressure: 20 MPa, injection pressure: 10 MPa) at 170° C. for 10 minutes to obtain 3 mm-thick carbon moldings for use as fuel cell separators. Table 9 shows the results.

TABLE 9

| | | | Example | | | | | | Comp. Ex. | | | | | |
|---|---|---|---|---|---|---|---|---|---|---|---|---|---|---|
| | | | 71 | 72 | 73 | 75 | 84 | 85 | 13 | 14 | 15 | 16 | 17 | 18 |
| Electroconductive | Thermosetting resin | | 20 | 25 | 20 | 15 | 20 | 25 | | | | | | |
| resin composition | (wt. %) | | | | | | | | | | | | | |
| | B-a + 1,3-PBO + | | | | | | | | | | | | | |
| | cat. 1 | | | | | | | | | | | | | |
| | Phenol resin N1 + | | | | | | | | 20 | 25 | 20 | 15 | 20 | 25 |
| | hexamethylene- | | | | | | | | | | | | | |
| | tetramine (wt. %) | | | | | | | | | | | | | |
| | Graphite | 1) GE-134 | 80 | | | | | | 80 | | | | | |
| | (wt. %) | 2) BSP-2 | | 75 | 80 | | 65 | 65 | | 75 | 80 | | 65 | 65 |
| | | 3) CBR | | | | 85 | 15 | 10 | | | | 85 | 15 | 10 |

| | | | | | | | | | | | | | |
|---|---|---|---|---|---|---|---|---|---|---|---|---|---|
| Properties | Thickness accuracy | 20 | 32 | 17 | 26 | 30 | 64 | 70 | 73 | 44 | 34 | 33 | 70 |
| | (1) (μm) | | | | | | | | | | | | |
| | Thickness accuracy | 48 | 40 | 45 | 47 | 58 | 95 | 104 | 124 | 69 | 48 | 59 | 104 |
| | (2) (μm) | | | | | | | | | | | | |
| | Density difference | 12 | 14 | 10 | 10 | 9 | 8 | 16 | 27 | 23 | 184 | 26 | 18 |
| | (g/cm³ × 10³) | | | | | | | | | | | | |
| | Density (g/cm³) | 1.89 | 1.85 | 1.89 | 2.00 | 1.91 | 1.86 | 1.91 | 1.83 | 1.88 | 1.91 | 1.90 | 1.83 |

### EXAMPLES 86 TO 88

The electroconductive resin compositions obtained in Examples 16, 20 and 22 were tableted at room temperature. A metal plate (surface-roughened austenitic stainless steel, 0.05 mm thickness) was inserted between two tablets prepared from the same composition, and the tablets with the metal plate were compression-molded in a mold at 170° C. and 30 MPa for 10 minutes, to obtain 1 mm-thick carbon moldings for use as fuel cell separators. The carbon moldings were subjected to the resistivity measurement and bending test. Table 10 shows the results.

### COMPARATIVE EXAMPLES 19 TO 21

The electroconductive resin compositions obtained in Comparative Examples 13, 15 and 16 were tableted at room temperature. A metal plate (surface-roughened austenitic stainless steel, 0.05 mm thickness) was inserted between two tablets prepared from the same composition, and the tablets with the metal plate were compression-molded in a mold at 170° C. and 30 MPa for 10 minutes. As a result, 1 mm-thick carbon moldings for use as fuel cell separators could only be obtained in Comparative Example 20 in which BSP-2 was used as a graphite. The obtained carbon moldings were subjected to the resistivity measurement and bending test. Table 10 shows the results.

TABLE 10

| | | | Example | | | Comp. Ex. | | |
|---|---|---|---|---|---|---|---|---|
| | | | 86 | 87 | 88 | 19 | 20 | 21 |
| Electroconductive | Thermosetting resin | | 20 | 20 | 15 | | | |
| resin composition | B-a + 1,3-PBO + cat. 1 | | | | | | | |
| | (wt. %) | | | | | | | |
| | Phenol resin N1 + | | | | | 20 | 20 | 15 |
| | hexamethylenetetramine | | | | | | | |
| | (wt. %) | | | | | | | |
| | Graphite | 1) GE-134 | 80 | | | 80 | | |
| | (wt. %) | 2) BSP-2 | | 80 | | | 80 | |
| | | 3) CBR | | | 85 | | | 85 |

| | | | | | | | |
|---|---|---|---|---|---|---|---|
| Properties | Resistivity (mΩ · cm) | 1.1 | 1.3 | 1.0 | * | 4.4 | * |
| | Flexural strength (MPa) | 73 | 67 | 80 | * | 49 | * |
| | Flexural modulus (GPa) | 17 | 29 | 35 | * | 14 | * |

* Not moldable

### EXAMPLES 89 TO 115

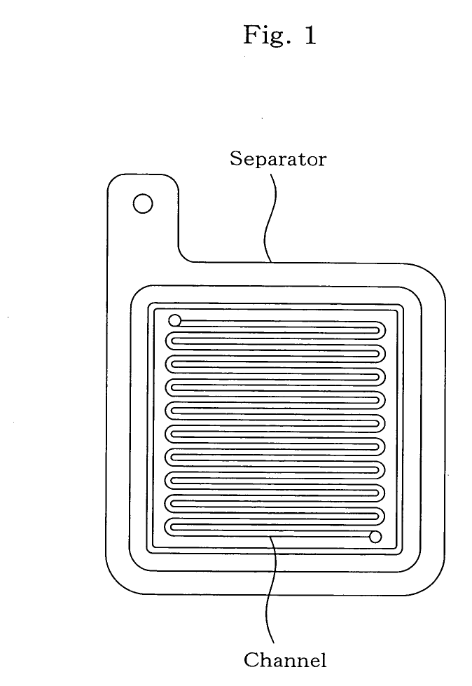

Nation (DuPont) as a solid polymer membrane and carbon paper as electrodes were bonded by a standard method to obtain integrated electrodes. The integrated electrodes were sandwitched between a pair of separators (FIG. 1) molded from the electroconductive resin composition obtained in one of Examples 1 to 8, 12 to 16, 19 to 26 and 37 to 42, to give a fuel cell provided with fuel gas flow channels and oxidant gas flow channels. It was confirmed that the fuel cell could be charged or discharged by supplying hydrogen and oxygen and effectively functioned as fuel cells. Specifically, the electroconductive resin composition was tableted and compression-molded in a mold of a predetermined shape at 170° C. and 30 MPa for 10 minutes. Thus, fuel cell separators (4 mm thickness) were obtained which had a configuration as shown in FIG. 1 and which were provided with channels as fuel gas and oxidant gas passageways. Using the obtained separators, a fuel cell was prepared by a standard method and subjected to current-voltage measurement.

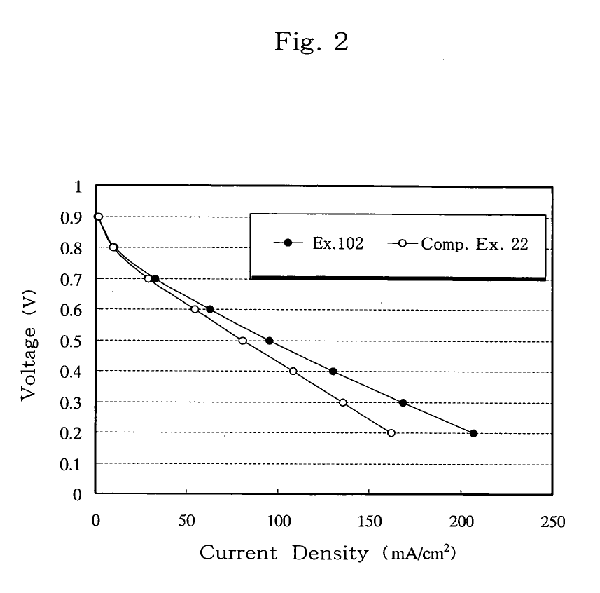

FIG. 2 shows the results of the current-voltage measurement of the fuel cell prepared using the separators obtained in Example 102 (in which the electroconductive resin composition obtained in Example 19 was used).

### COMPARATIVE EXAMPLE 22

The electroconductive resin composition obtained in Comparative Example 14 was tableted and compression-molded in a mold of a predetermined shape at 170° C. and 30 MPa for 10 minutes. Thus, fuel cell separators (4 mm thickness) were obtained which had a configuration as shown in FIG. 1 and which were provided with channels as fuel gas and oxidant gas passageways. Using the obtained separators, a fuel cell was prepared by a standard method and subjected to current-voltage measurement. FIG. 2 shows the results.

As is apparent from Tables 1 and 2, the carbon moldings for use as fuel cell separators obtained in the Examples in which solution blending was employed were well balanced and remarkably excellent in gas impermeability, electroconductivity and mechanical strength, as compared with the carbon moldings obtained in the Comparative Examples using the conventionally used phenol resin. Further, the carbon moldings of the Examples had a low density and thus are very lightweight. In particular, the carbon moldings of the Examples were well balanced and remarkably excellent in gas impermeability, electroconductivity, mechanical strength and lightweight properties, regardless of the type of resin components (Table 1) and regardless of the type of graphite (Table 2).

From the viewpoint of production worker safety and global environmental protection, it is preferable not to use organic solvents. As is apparent from Tables 3 to 9, in the Examples, carbon moldings for use as fuel cell separators were easily obtained by molding electroconductive resin compositions prepared by dry blending without using organic solvents. The obtained carbon moldings were well balanced and remarkably excellent in gas impermeability, electroconductivity, mechanical strength and lightweight properties. Accordingly, the fuel cell separator of the present invention is more useful than hitherto known fuel cell separators prepared using phenol resins.

Furthermore, Tables 7 and 8 reveal that the carbon moldings of the Examples, even when molded in a short time, are excellent in gas impermeability, electroconductivity, mechanical strength and lightweight properties. Therefore, the separators of the Examples can be produced with improved productivity and thus at greatly reduced cost.

Moreover, it was found that carbon moldings for use as fuel cell separators can be easily prepared by transfer molding. Thus, the carbon moldings of the Examples not only are improved in productivity, but also have extremely high thickness accuracy and remarkably low density irregularities as compared with hitherto known fuel cell separators prepared using phenol resins, as is apparent from Table 9.

Furthermore, Table 10 reveals that, since the electroconductive resin composition for use in the present invention does not generate volatiles during the curing reaction, the molded resin has improved adhesion to the metal plate, resulting in separators with remarkably excellent electroconductivity.

The fuel cells of the present invention, which are prepared using the carbon moldings of the Examples as separators are capable of being charged or discharged and effectively function. Further, as shown in FIG. 2, the fuel cells thus prepared have better power generation characteristics than hitherto known fuel cells prepared using used phenol resins.

These results demonstrate that the carbon moldings obtained in the Examples are useful as fuel cell separators.

1. A fuel cell separator obtainable by hot-molding an electroconductive resin composition that comprises:
a thermosetting resin (A) comprising a dihydrobenzoxazine ring-containing compound (a), a compound (b) reactive with a phenolic hydroxyl group formed by opening of a dihydrobenzoxazine ring, and a latent curing agent (c); and
an electroconductive material (B).

2. The fuel cell separator according to claim 1, obtainable by hot-molding an electroconductive resin composition that comprises 1 to 50 wt. % of the thermosetting resin (A) and 99 to 50 wt. % of the electroconductive material (B).

3. The fuel cell separator according to claim 1, wherein the electroconductive material (B) is a graphite.

4. The fuel cell separator according to claim 3, wherein the graphite is at least one member selected from the group consisting of expanded graphites, flake graphites and artificial graphites.

5. The fuel cell separator according to claim 3, wherein the graphite is a pulverized product or cutting powder of a graphite material.

6. The fuel cell separator according to claim 1, wherein the dihydrobenzoxazine ring-containing compound (a) has at least one functional group represented by formula (1) 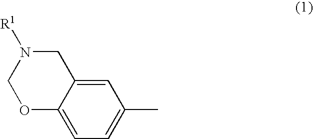
wherein R¹ is a substituted or unsubstituted alkyl group, a substituted or unsubstituted aryl group, a substituted or unsubstituted alkenyl group, a substituted or unsubstituted alkynyl group, or a substituted or unsubstituted aralkyl group.

7. The fuel cell separator according to claim 1, wherein the compound (b) reactive with a phenolic hydroxyl group formed by opening of a dihydrobenzoxazine ring has at least one functional group represented by formula (2) 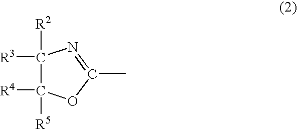
wherein R², R³, R⁴ and R⁵ are the same or different and each represents a hydrogen atom, an alkyl group or an aryl group.

8. The fuel cell separator according to claim 1, wherein the compound (b) reactive with a phenolic hydroxyl group formed by opening of a dihydrobenzoxazine ring is an epoxy resin.

9. The fuel cell separator according to claim 1, wherein the latent curing agent (c) is a compound that forms, when decomposed, an acidic compound and an amine compound.

10. The fuel cell separator according to claim 9, wherein the compound that forms, when decomposed, an acidic compound and an amine compound is a reaction product of an organic or inorganic acid with an amine compound.

11. The fuel cell separator according to claim 10, wherein the organic acid is at least one member selected from the group consisting of organic sulfonic acids, organic phosphoric acids and organic carboxylic acids.

12. The fuel cell separator according to claim 10, wherein the amine compound is at least one member selected from the group consisting of monoalkanolamines, dialkanolamines and trialkanolamines, all of which may be substituted and are represented by formula (3) 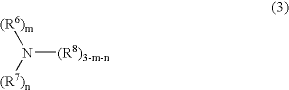
wherein R⁶ and R⁷ are the same or different and each represents a hydrogen atom, a substituted or unsubstituted C₁₋₁₀ alkyl group or a substituted or unsubstituted C₆-10 aryl group; R⁸ is a hydroxyl-containing C₁₋₈ alkyl group; m and n are each 0, 1 or 2, and m+n≦2.

13. The fuel cell separator according to claim 1, which has a resistivity of 30 mΩ·cm or less, a helium permeability of 30 cm³/m²·24 h-atm or less and a flexural strength of 30 to 100 MPa.

14. The fuel cell separator according to claim 1, which has a metal plate incorporated therein.

15. A process for producing a fuel cell separator, comprising the steps of:
compressing into tablets an electroconductive resin composition that comprises a thermosetting resin (A) comprising a dihydrobenzoxazine ring-containing compound (a), a compound (b) reactive with a phenolic hydroxyl group formed by opening of a dihydrobenzoxazine ring, and a latent curing agent (c), and an electroconductive material (B); and
heat-curing the tablets by compression molding.

16. A process for producing a fuel cell separator, comprising the step of heat-curing, by transfer molding or injection molding, an electroconductive resin composition that comprises:
a thermosetting resin (A) comprising a dihydrobenzoxazine ring-containing compound (a), a compound (b) reactive with a phenolic hydroxyl group formed by opening of a dihydrobenzoxazine ring, and a latent curing agent (c); and
an electroconductive material (B).

17. A fuel cell comprising a fuel cell separator according to claim 1.

18. The fuel cell according to claim 17, which is a polymer electrolyte fuel cell.
